(19) United States
(12) Patent Application Publication
(10) Pub. No.: US 2006/0290610 A1
(43) Pub. Date: Dec. 28, 2006

(54) Plasma display apparatus and method of driving the same

(75) Inventors: Seonghak Moon, Seoul (KR); Taehyung Kim, Seoul (KR); Byung Goo Kong, Yongin-si (KR); Chung-Wook Roh, Seoul (KR); Byeong Kil Ahn, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/474,950

(22) Filed: Jun. 27, 2006

(30) Foreign Application Priority Data
Jun. 28, 2005 (KR) 10-2005-0056601
Jun. 28, 2005 (KR) 10-2005-0056603
Jul. 1, 2005 (KR) 10-2005-0059433

(51) Int. Cl. G09G 3/28

(52) U.S. Cl. 345/68

(57) ABSTRACT

A plasma display apparatus and a method of driving the plasma display apparatus are disclosed. The plasma display apparatus includes a plasma display panel including a scan electrode, a sustain voltage source, an inductor, an energy supply/recovery capacitor, and a maintenance capacitor. The inductor and the energy supply/recovery capacitor form a current path for supplying/recovering a sustain voltage to/from the plasma display panel, and for forming a current path for supplying/recovering one half of the sustain voltage to/from the plasma display panel. The maintenance capacitor forms a current path for maintaining a voltage of the plasma display panel at one half of the sustain voltage.

This Non-provisional application claims priority under 35 U.S.C. § 119(a) on Korea Patent Application Nos. 10-2005-0056601 and 10-2005-0056603 filed on Jun. 28, 2005 and Korea Patent Application No. 10-2005-0059433 filed on Jul. 1, 2005 the entire contents of which are hereby incorporated by reference.

### BACKGROUND OF THE INVENTION

1. Field of the Invention

This document relates to a display apparatus, and more particularly, to a plasma display apparatus.

2. Description of the Background Art

Generally, our of display apparatuses, a plasma display apparatus comprises a plasma display panel and a driver for driving the plasma display panel.

There is a problem in that a cathode ray tube is heavy and bulky. Accordingly, various flat display apparatuses have been developed. Examples of the flat display apparatuses includes a liquid crystal display (LCD), a field emission display (FED), a plasma display panel (PDP), and an electro-luminescence (EL) display apparatus. The PDP uses a gas discharge, and has an advantage in easily manufacturing a large-sized panel. Recently, most of the PDPs have a three-electrode surface-discharge type structure in which a scan electrode and a sustain electrode are formed on a front substrate and an address electrode is formed on a rear substrate.

The three-electrode surface-discharge type PDP is driven by dividing a frame into several subfields. The number of emissions, which is proportionate to weight values of video data, is generated in each of the subfields such that an image is displayed. Each of the subfields comprises a reset period, an address period and a sustain period.

In the reset period, wall charges are uniformly formed within a discharge cell. In the address period, a selective address discharge depending on a logical value of the video data is generated. In the sustain period, a discharge is maintained within a discharge cell selected by the generation of the address discharge.

In the three-electrode surface-discharge type PDP thus driven, a high voltage of several hundreds of volt is required in the generation of the address discharge and the sustain discharge. Accordingly, an energy recovery apparatus is used in the three-electrode surface-discharge type PDP to lower a driving voltage required in the generation of the address discharge and the sustain discharge.

FIG. 1 is a circuit diagram of an energy recovery apparatus of a related art plasma display apparatus.

Referring to FIG. 1, an energy recovery apparatus of a related art plasma display apparatus disclosed in U.S. Pat. No. 5,081,400 by Weber has a symmetric structure across a panel capacitor Cp.

Only an energy recovery apparatus installed in a scan electrode Y of the PDP is illustrated in FIG. 1. The panel capacitor Cp equivalently indicates a capacitance formed between the scan electrode Y and the sustain electrode Z of the PDP.

An energy recovery apparatus 2 of a related art plasma display apparatus comprises an energy recovery/supply unit 4 and a sustain pulse supply unit 6.

The energy recovery/supply unit 4 recovers a reactive energy of the PDP, which does not participate in a discharge of PDP during a sustain period, and supplies the recovered energy to the panel capacitor Cp.

The energy recovery/supply unit 4 comprises a capacitor Cs for storing the recovered energy, an inductor L, a first switch SW1 and a first diode D1. The inductor L is connected between the capacitor Cs and a second node N2 which is a common terminal of a sustain voltage supply control unit 8 and a ground voltage supply control unit 10. The first switch SW1 and the first diode D1 are connected in series between capacitor Cs and the inductor L to form a current path for supplying energy stored in the capacitor Cs to the panel capacitor Cp.

The energy recovery/supply unit 4 comprises a second switch SW2, a second diode D2, a third diode D3 and a fourth diode D4. The second switch SW2 and the second diode D2 are connected in series between the capacitor Cs and a first node N1 which is a common terminal of the first diode D1 and the inductor L to form a current path for recovering the reactive energy from the panel capacitor Cp. The third diode D3 and the fourth diode D4 are connected in series between a sustain voltage source (not shown) and a ground voltage source (not shown).

The capacitor Cs recovers a voltage stored in the panel capacitor Cp when generating a sustain discharge. Then the capacitor Cs again supplies the voltage stored in the capacitor Cs to the panel capacitor Cp.

A voltage of Vs/2 being one half of a sustain voltage Vs is charged to the capacitor Cs. The inductor L has a fixed inductance. The inductor L and the panel capacitor Cp form a resonance circuit.

For this, the first to fourth switches SW1 to SW4 control a current flow. An inner diode for controlling a current flow is formed in the first to fourth switches SW1 to SW4.

When the voltage charged to the capacitor Cs is supplied to the panel capacitor Cp, the first diode D1 prevents an inverse current from the panel capacitor Cp. When the capacitor Cs recovers the voltage stored in the panel capacitor Cp, the second diode D2 prevents an inverse current from the capacitor Cs.

The third diode D3 prevents an inverse current flowing from the sustain voltage source to the first node N1. The fourth diode D4 prevents an inverse current from flowing the first node N1 to the ground voltage source.

The sustain pulse supply unit 6 supplies a sustain pulse having the sustain voltage Vs and the ground voltage level GND to the scan electrode Y of the PDP during the sustain period. The sustain pulse supply unit 6 comprises the sustain voltage supply unit 8 and the ground voltage supply unit 10.

The sustain voltage supply unit 8 controls the supply of the sustain voltage Vs to the scan electrode Y of the PDP during a setup period of a reset period and the sustain period. The sustain voltage supply unit 8 comprises the third switch SW3 connected between the sustain voltage source and the second node N2.

The ground voltage supply unit 10 controls the supply of the ground voltage level GND to the scan electrode Y of the PDP during the sustain period. The ground voltage supply unit 10 comprises the fourth switch SW4 connected between the ground voltage source and the second node N2.

FIG. 2 illustrates On/Off timing of switches of the energy recovery apparatus of FIG. 1, and an output waveform of a panel capacitor of the energy recovery apparatus of FIG. 1.

Referring to FIG. 2, suppose that before a period t1, a voltage of 0V is stored in the panel capacitor Cp, and the voltage of Vs/2 being one half of the sustain voltage Vs is stored in the capacitor Cs.

The first switch SW1 is turned on during the period t1 such that a current path passing through the capacitor Cs, the first switch SW1, the first diode D1, the inductor L and the panel capacitor Cp is formed, and the inductor L and the panel capacitor Cp generate serial resonance. A voltage Vp and a current ICp of the panel capacitor Cp are expressed by the following equation 1.

$${V}_{p} ( t ) = \frac{{V}_{s}}{2} ( 1 - {ⅇ}^{- {sw}_{n} t} cos w {}_{d} t - \frac{s {ⅇ}^{- {sw}_{n} t}}{\sqrt{1 - {s}^{2}}} sin {w}_{d} t ) \\ {IC}_{p} ( t ) = \frac{{V}_{s} {ⅇ}^{{sw}_{n} t}}{2 {Lw}_{d}} sin {w}_{d} t \\ Here , \\ {w}_{n} = 1 / \sqrt{{LC}_{p}} , \\ s = {R}_{eq} \sqrt{{C}_{p} / L} , \\ {w}_{d} = {w}_{n} \sqrt{1 - {s}^{2}} , \\ {R}_{eq} \qquad [ Equation 1 ]$$

indicates the total of parasitic resistances formed in the current path.

As a result, the voltage Vp of the panel capacitor Cp rises from the ground voltage level GND to the sustain voltage Vs in the period t1. A current IL flowing in the inductor L rises to

$$\frac{{V}_{s}}{2} \sqrt{\frac{{C}_{p}}{L}} ,$$

and then falls to 0.

The first switch SW1 and the third switch SW3 are turned on during a period t2 such that a first current path passing through the capacitor Cs, the first switch SW1, the first diode D1, the inductor L and the second node N2 and a second current path passing through the sustain voltage source, the third switch SW3 and the panel capacitor Cp are formed.

As a result, a voltage of the panel capacitor Cp is maintained at the sustain voltage Vs and a gas discharge current Igas flows inside the PDP. In the period t2, the inductor L and a parasitic capacitor on the current path generate parasitic resonance such that an inverse current with a predetermined peak value Ir flows in the inductor L. The inverse current flowing in the inductor L flows in the third switch SW3, the inductor L and the fourth diode D4. A magnitude of the inverse current is expressed by the following equation 2.

$${I}_{L} ( t ) = - {I}_{r} + \frac{{V}_{f}}{L} t \qquad [ Equation 2 ]$$

Here, Vⱼ indicates a turn-on voltage of the fourth diode D4 and has a voltage of about 0.7 V.

The inverse current continuously flows in the inductor L until the inverse current is 0. The inverse current is called a freewheeling current. The freewheeling current increases current stress of the third switch SW3 and the fourth diode D4.

The first switch SW1 is turned off during a period t3 such that a current path passing through the sustain voltage source, the third switch SW3 and the panel capacitor Cp is formed. As a result, a voltage of the panel capacitor Cp is maintained at the sustain voltage Vs.

The third switch SW3 is turned off and the second switch SW2 is turned on during a period t4 such that a current path passing through the panel capacitor Cp, the inductor L, the second diode D2, the second switch SW2 and the capacitor Cs is formed, and the inductor L and the panel capacitor Cp generate serial resonance. The voltage Vp and the current ICp of the panel capacitor Cp are expressed by the following equation 3.

$${V}_{p} ( t ) = \frac{{V}_{s}}{2} ( 1 + {ⅇ}^{- {sw}_{n} t} cos {w}_{d} t + \frac{s {ⅇ}^{- {sw}_{n} t}}{\sqrt{1 - {s}^{2}}} sin {w}_{d} t ) \\ {IC}_{p} ( t ) = - \frac{{V}_{s} {ⅇ}^{{sw}_{n} t}}{2 {Lw}_{d}} sin {w}_{d} t \qquad [ Equation 3 ]$$

As a result, the voltage Vp of the panel capacitor Cp falls from the sustain voltage Vs to the ground voltage level GND in the period t4. The current IL flowing in the inductor L falls to

$$- \frac{{V}_{s}}{2} \sqrt{\frac{{C}_{p}}{L}} ,$$

and then rises to 0.

In a period t5, the fourth switch SW4 is turned on, and then the second switch SW2 is turned on. As a result, the voltage of the panel capacitor Cp is maintained at the ground voltage level GND.

Since the voltage Vp stored in the panel capacitor Cp sharply falls from the sustain voltage Vs to the ground voltage level GND, the unwanted inductor current Ir flows in the fourth switch SW4, the inductor L and the fourth diode D4. An inverse current flowing in the inductor L is expressed by the following equation 4.

$${I}_{L} ( t ) = {I}_{r} - \frac{{V}_{f}}{L} t \qquad [ Equation 4 ]$$

The inverse current continuously flows in the inductor L until the inverse current is 0. The inverse current is called a freewheeling current. The freewheeling current increases current stress of the third switch SW3 and the fourth diode D4.

As described above, when energy is charged or discharged to or from the panel capacitor Cp in the energy recovery apparatus of the plasma display apparatus, the freewheeling current causes the very much current stress on driving elements of the energy recovery apparatus. Therefore, withstanding conditions of the driving elements need to be improved.

In other words, since the energy recovery apparatus of the related art plasma display apparatus uses the driving elements with the good withstanding conditions, the manufacturing cost increases. Further, the unwanted freewheeling current increases power consumption.

Moreover, since the serial resonance of the inductor L and the panel capacitor Cp is used, it is difficult to achieve a completely soft switching operation by parasitic elements of the circuit Since charging time and discharging time of the PDP is not controlled, it is difficult to simultaneously secure both a good discharge characteristic and high recovery efficiency.

### SUMMARY OF THE INVENTION

Accordingly, an object of the present invention is to solve at least the problems and disadvantages of the background art.

Embodiments of the present invention provide a plasma display apparatus capable of reducing the manufacturing cost and improving energy recovery efficiency.

The embodiments of the present invention also provide a plasma display apparatus capable of reducing power consumption by reducing a parasitic resistance.

According to an aspect, there is provided a plasma display apparatus comprising a plasma display panel comprising a scan electrode, a sustain voltage source for supplying a sustain voltage to the plasma display panel, an inductor for recovering a voltage stored in the plasma display panel by resonance of the inductor and the plasma display panel, and for supplying a recovered voltage to the plasma display panel by resonance of the inductor and the plasma display panel, an energy supply/recovery capacitor for forming a current path for supplying/recovering a sustain voltage to/from the plasma display panel, and for forming a current path for supplying/recovering one half of the sustain voltage to/from the plasma display panel, the inductor is used to form the current paths, and a maintenance capacitor, formed between the sustain voltage source and the plasma display panel, for forming a current path for maintaining a voltage of the plasma display panel at one half of the sustain voltage.

According to another aspect, there is provided a plasma display apparatus comprising a plasma display panel comprising a scan electrode, a first capacitor and a second capacitor, which are connected between a sustain voltage source and a ground voltage source, a sustain voltage supply control unit, connected between the sustain voltage source and the scan electrode, for controlling the supply of a sustain voltage to the scan electrode, a ground voltage supply control unit, connected between the ground voltage source and the scan electrode, for controlling the supply of a ground voltage level to the scan electrode, a third capacitor connected between the sustain voltage supply control unit and the ground voltage supply control unit, an energy supply control unit, connected between a common terminal of the first capacitor and the second capacitor and the scan electrode, for controlling the supply of energy stored in the second capacitor to the scan electrode, an energy recovery control unit, connected with the energy supply control unit in parallel between the common terminal of the first capacitor and the second capacitor and the scan electrode, for controlling the supply of energy recovered from the scan electrode of the plasma display panel to the second capacitor, and a first inductor connected between a common terminal of the energy supply control unit and the energy recovery control unit and the scan electrode.

According to still another aspect, there is provided a plasma display apparatus comprising a plasma display panel comprising a scan electrode, a first capacitor and a second capacitor, which are connected between a sustain voltage source and a ground voltage source, a sustain voltage supply control unit, connected between the sustain voltage source and the scan electrode, for controlling the supply of a sustain voltage to the scan electrode, a ground voltage supply control unit, connected between the ground voltage source and the scan electrode, for controlling the supply of a ground voltage level to the scan electrode, a third capacitor and a fourth capacitor, which are connected in series between the sustain voltage supply control unit and the ground voltage supply control unit, a first inductor connected between a common terminal of the first capacitor and the second capacitor and a common terminal of the third capacitor and the fourth capacitor, a first energy recovery control unit and a second energy supply control unit, which are connected in parallel between the common terminal of the first capacitor and the second capacitor and the first inductor, a second inductor connected between the common terminal of the third capacitor and the fourth capacitor and the scan electrode, and a first energy supply control unit and a second energy recovery control unit, which are connected in parallel between the first inductor and the second inductor

According to yet still another aspect, there is provided a plasma display apparatus comprising a plasma display panel comprising a scan electrode, a first capacitor and a second capacitor, which are connected between a sustain voltage source and a ground voltage source, a sustain voltage supply control unit, connected between the sustain voltage source and the scan electrode, for controlling the supply of a sustain voltage to the scan electrode, a ground voltage supply control unit, connected between the ground voltage source and the scan electrode, for controlling the supply of a ground voltage level to the scan electrode, a third capacitor and a fourth capacitor, which are connected in series between the sustain voltage supply control unit and the ground voltage supply control unit, a first energy supply control unit and a first energy recovery control unit, which are connected in parallel between a common terminal of the first capacitor and the second capacitor and a common terminal of the third capacitor and the fourth capacitor, and a second energy supply control unit and a second energy recovery control unit, which are connected in parallel between the common terminal of the third capacitor and the fourth capacitor and the scan electrode.

According to further still another aspect, there is provided a method of driving a plasma display apparatus comprising increasing a voltage of a scan electrode of a plasma display panel from a ground voltage level to one half of a sustain voltage, maintaining the voltage of the scan electrode at one half of the sustain voltage, increasing the voltage of the scan electrode from one half of the sustain voltage to the sustain voltage, maintaining the voltage of the scan electrode at the sustain voltage, decreasing the voltage of the scan electrode from the sustain voltage to one half of the sustain voltage, and decreasing the voltage of the scan electrode from one half of the sustain voltage to the ground voltage level.

### BRIEF DESCRIPTION OF THE DRAWINGS

The invention will be described in detail with reference to the following drawings in which like numerals refer to like elements.

FIG. 1 is a circuit diagram of an energy recovery apparatus of a related art plasma display apparatus;

FIG. 2 illustrates On/Off timing of switches of the energy recovery apparatus of FIG. 1 and an output waveform of a panel capacitor of the energy recovery apparatus of FIG. 1.

FIG. 3 is a perspective view of a plasma display panel of a plasma display apparatus according to a first embodiment of the present invention;

FIG. 4 is a circuit diagram of the plasma display apparatus according to the first embodiment of the present invention;

FIG. 5 is a timing chart of switches of the plasma display apparatus according to the first embodiment of the present invention;

FIGS. 6 through 11 are circuit diagrams of a current path formed depending on on/off switching operations of the switches of FIG. 5;

FIG. 12 is a circuit diagram of the plasma display apparatus according to a second embodiment of the present invention;

FIG. 13 is a timing chart of switches of the plasma display apparatus according to the second embodiment of the present invention;

FIGS. 14 through 21 are circuit diagrams of a current path formed depending on on/off switching operations of the switches of FIG. 13;

FIG. 22 is a circuit diagram of the plasma display apparatus according to a third embodiment of the present invention;

FIG. 23 is a timing chart of switches of the plasma display apparatus according to the third embodiment of the present invention; and

FIGS. 24 through 32 are circuit diagrams of a current path formed depending on on/off switching operations of the switches of FIG. 23.

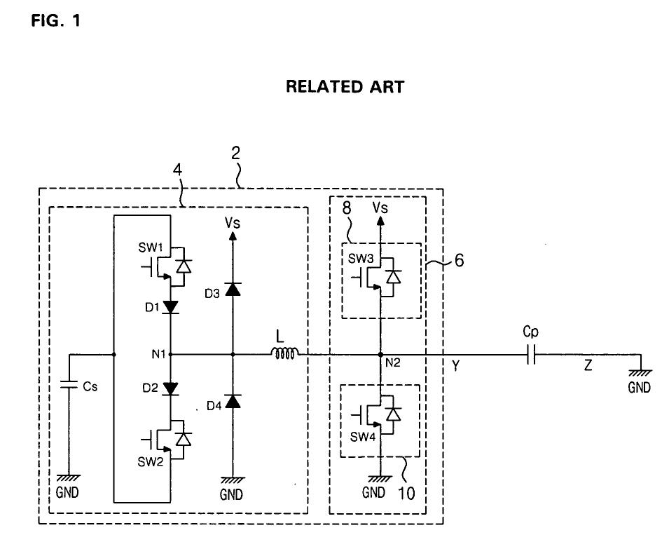

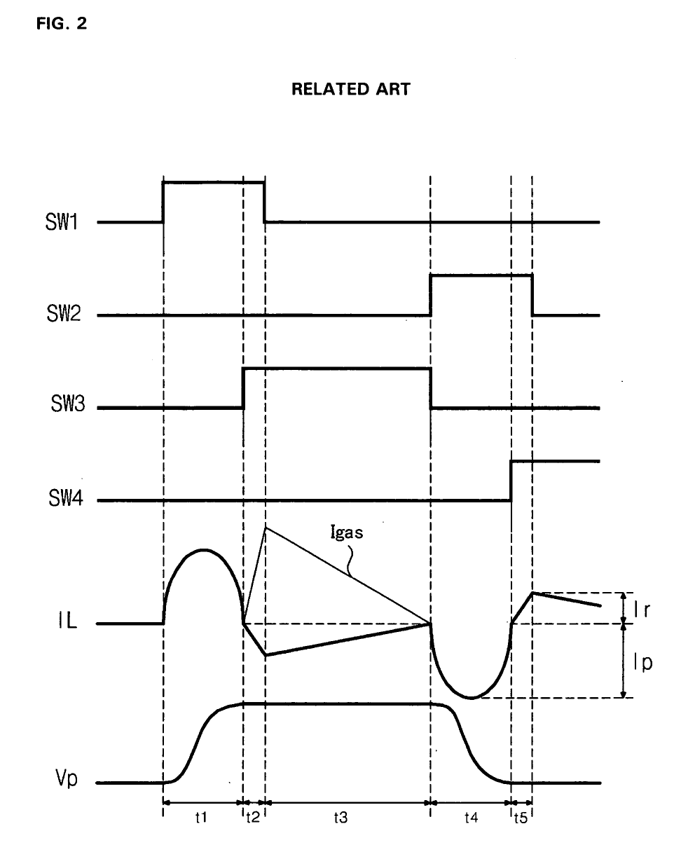

### DETAILED DESCRIPTION OF PREFERRED EMBODIMENTS

Preferred embodiments of the present invention will be described in a more detailed manner with reference to the drawings.

A plasma display apparatus according to embodiments of the present invention comprises a plasma display panel comprising a scan electrode, a sustain voltage source for supplying a sustain voltage to the plasma display panel, an inductor for recovering a voltage stored in the plasma display panel by resonance of the inductor and the plasma display panel, and for supplying a recovered voltage to the plasma display panel by resonance of the inductor and the plasma display panel, an energy supply/recovery capacitor for forming a current path for supplying/recovering a sustain voltage to/from the plasma display panel, and for forming a current path for supplying/recovering one half of the sustain voltage to/from the plasma display panel, the inductor is used to form the current paths, and a maintenance capacitor, formed between the sustain voltage source and the plasma display panel, for forming a current path for maintaining a voltage of the plasma display panel at one half of the sustain voltage.

The energy supply/recovery capacitor may comprise a second capacitor and a fourth capacitor, the second capacitor may form the current path for supplying/recovering the sustain voltage to/from the plasma display panel, and the fourth capacitor may form the current path for supplying/recovering one half of the sustain voltage to/from the plasma display panel.

The energy supply/recovery capacitor may comprise a third capacitor, and the maintenance capacitor for forming the current path for maintaining the voltage of the plasma display panel at one half of the sustain voltage may be the third capacitor.

The inductor may comprise a first inductor and a second inductor, the first inductor and the second capacitor may form the current path for supplying/recovering the sustain voltage to/from the plasma display panel, and the second inductor and the fourth capacitor may form the current path for supplying/recovering one half of the sustain voltage to/from the plasma display panel.

The inductor may comprise a first inductor, a second inductor, a third inductor and a fourth inductor, the first inductor and the second capacitor may form a current path for supplying the sustain voltage to the plasma display panel, the second inductor and the fourth capacitor may form a current path for recovering one half of the sustain voltage from the plasma display panel, the third inductor and the second capacitor may form a current path for recovering the sustain voltage from the plasma display panel, and the fourth inductor and the fourth capacitor may form a current path for supplying one half of the sustain voltage to the plasma display panel.

A current path for supplying the sustain voltage to the plasma display panel may be the same as a current path for supplying one half of the sustain voltage to the plasma display panel, and a current path for recovering the sustain voltage from the plasma display panel may be the same as a current path for recovering one half of the sustain voltage from the plasma display panel.

The energy supply/recovery capacitor may comprise a third capacitor, and the maintenance capacitor for forming the current path for maintaining the voltage of the plasma display panel at one half of the sustain voltage may be the third capacitor.

A plasma display apparatus according to the embodiments of the present invention comprises a plasma display panel comprising a scan electrode, a first capacitor and a second capacitor, which are connected between a sustain voltage source and a ground voltage source, a sustain voltage supply control unit, connected between the sustain voltage source and the scan electrode, for controlling the supply of a sustain voltage to the scan electrode, a ground voltage supply control unit, connected between the ground voltage source and the scan electrode, for controlling the supply of a ground voltage level to the scan electrode, a third capacitor connected between the sustain voltage supply control unit and the ground voltage supply control unit, an energy supply control unit, connected between a common terminal of the first capacitor and the second capacitor and the scan electrode, for controlling the supply of energy stored in the second capacitor to the scan electrode, an energy recovery control unit, connected with the energy supply control unit in parallel between the common terminal of the first capacitor and the second capacitor and the scan electrode, for controlling the supply of energy recovered from the scan electrode of the plasma display panel to the second capacitor, and a first inductor connected between a common terminal of the energy supply control unit and the energy recovery control unit and the scan electrode.

The sustain voltage supply control unit may comprise a first switch and a third switch, which are connected in series between the sustain voltage source and the scan electrode, and the ground voltage supply control unit may comprise a second switch and a fourth switch, which are connected in series between the ground voltage source and the scan electrode.

The third capacitor may be connected between a common terminal of the first switch and the third switch and a common terminal of the second switch and the fourth switch.

The energy supply control unit may comprise a fifth switch connected between the common terminal of the first capacitor and the second capacitor and the inductor.

The energy recovery control unit may comprise a sixth switch connected between the common terminal of the first capacitor and the second capacitor and the inductor.

A plasma display apparatus according to the embodiments of the present invention comprises a plasma display panel comprising a scan electrode, a first capacitor and a second capacitor, which are connected between a sustain voltage source and a ground voltage source, a sustain voltage supply control unit, connected between the sustain voltage source and the scan electrode, for controlling the supply of a sustain voltage to the scan electrode, a ground voltage supply control unit, connected between the ground voltage source and the scan electrode, for controlling the supply of a ground voltage level to the scan electrode, a third capacitor and a fourth capacitor, which are connected in series between the sustain voltage supply control unit and the ground voltage supply control unit, a first inductor connected between a common terminal of the first capacitor and the second capacitor and a common terminal of the third capacitor and the fourth capacitor, a first energy recovery control unit and a second energy supply control unit, which are connected in parallel between the common terminal of the first capacitor and the second capacitor and the first inductor, a second inductor connected between the common terminal of the third capacitor and the fourth capacitor and the scan electrode, and a first energy supply control unit and a second energy recovery control unit, which are connected in parallel between the first inductor and the second inductor.

The sustain voltage supply control unit may comprise a first switch and a second switch, which are connected in series between the sustain voltage source and the scan electrode, and the ground voltage supply control unit may comprise a third switch and a fourth switch, which are connected in series between the ground voltage source and the scan electrode.

The first energy supply control unit may comprise a fifth switch and a first diode, which are connected between the first inductor and the second inductor.

The second energy supply control unit may comprise a sixth switch and a second diode, which are connected between the common terminal of the first capacitor and the second capacitor and the first inductor.

The first energy recovery control unit may comprise a seventh switch and a third diode, which are connected between the common terminal of the first capacitor and the second capacitor and the first inductor.

The second energy recovery control unit may comprise an eighth switch and a fourth diode, which are connected between the first inductor and the second inductor.

The voltage charge to the first capacitor may equal 50% of the sustain voltage, the voltage charge to the second capacitor may equal 50% of the sustain voltage, the voltage charge to the third capacitor may equal 25% of the sustain voltage, and the voltage charge to the fourth capacitor may equal 25% of the sustain voltage.

A plasma display apparatus according to the embodiments of the present invention comprises a plasma display panel comprising a scan electrode, a first capacitor and a second capacitor, which are connected between a sustain voltage source and a ground voltage source, a sustain voltage supply control unit, connected between the sustain voltage source and the scan electrode, for controlling the supply of a sustain voltage to the scan electrode, a ground voltage supply control unit, connected between the ground voltage source and the scan electrode, for controlling the supply of a ground voltage level to the scan electrode, a third capacitor and a fourth capacitor, which are connected in series between the sustain voltage supply control unit and the ground voltage supply control unit, a first energy supply control unit and a first energy recovery control unit, which are connected in parallel between a common terminal of the first capacitor and the second capacitor and a common terminal of the third capacitor and the fourth capacitor, and a second energy supply control unit and a second energy recovery control unit, which are connected in parallel between the common terminal of the third capacitor and the fourth capacitor and the scan electrode.

The sustain voltage supply control unit may comprise a first switch connected between the sustain voltage source and the third capacitor, and a second switch connected between the third capacitor and the scan electrode, and the ground voltage supply control unit may comprise a third switch connected between the ground voltage source and the fourth capacitor, and a fourth switch connected between the fourth capacitor and the scan electrode.

The second energy supply control unit may comprise a fifth switch connected between a common terminal of the third capacitor and the fourth capacitor and a common terminal of the first switch and the second switch, and a first inductor connected between the common terminal of the first capacitor and the second capacitor and the fifth switch.

The first energy recovery control unit may comprise a sixth switch connected between a common terminal of the third switch and the fourth switch and a common terminal of the first capacitor and the second capacitor, and a third inductor connected between a common terminal of the third capacitor and the fourth capacitor and the sixth switch.

The second energy recovery control unit may comprise a second inductor connected between a common terminal of the first switch and the second switch and a common terminal of the second switch and the scan electrode, and a seventh switch connected between a common terminal of the third capacitor and the fourth capacitor and the second inductor.

The first energy supply control unit may comprise an eighth switch connected between a common terminal of the third capacitor and the fourth capacitor and a common teal of the third switch and the fourth switch, and a fourth inductor connected between a common terminal of the third switch and the scan electrode and the eighth switch.

The voltage charge to the first capacitor may equal 50% of the sustain voltage, the voltage charge to the second capacitor may equal 50% of the sustain voltage, the voltage charge to the third capacitor may equal 25% of the sustain voltage, and the voltage charge to the fourth capacitor may equal 25% of the sustain voltage.

A method of driving a plasma display apparatus according to the embodiments of the present invention comprises increasing a voltage of a scan electrode of a plasma display panel from a ground voltage level to one half of a sustain voltage, maintaining the voltage of the scan electrode at one half of the sustain voltage, increasing the voltage of the scan electrode from one half of the sustain voltage to the sustain voltage, maintaining the voltage of the scan electrode at the sustain voltage, decreasing the voltage of the scan electrode from the sustain voltage to one half of the sustain voltage, and decreasing the voltage of the scan electrode from one half of the sustain voltage to the ground voltage level.

Hereinafter, exemplary embodiments of the present invention will be described in detail with reference to the attached drawings.

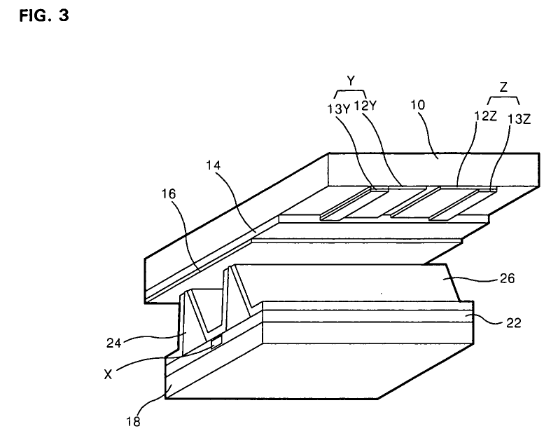

FIG. 3 is a perspective view of a plasma display panel of a plasma display apparatus according to a first embodiment of the present invention.

Referring to FIG. 3, a plasma display panel of a plasma display apparatus according to a first embodiment of the present invention comprises a scan electrode Y and a sustain electrode Z formed on a front substrate 10 of a discharge cell, and an address electrode X formed on a rear substrate 18 of the discharge cell.

The scan electrode Y and the sustain electrode Z each comprises transparent electrodes 12Y and 12Z and bus electrodes 13Y and 13Z. The bus electrodes 13Y and 13Z have linewidth less than the linewidth of the transparent electrodes 12Y and 12Z, and are formed at an edge of one side of the transparent electrodes 12Y and 12Z.

The transparent electrodes 12Y and 12Z are made of a transparent indium-tin-oxide (ITO) material, and are formed on the front substrate 10. The bus electrodes 13Y and 13Z are made of a metal material such as Cr, and are formed on the transparent electrodes 12Y and 12Z. The bus electrodes 13Y and 13Z reduces voltage drop caused by the transparent electrodes 12Y and 12Z with a high resistance.

An upper dielectric layer 14 and a protective layer 16 are formed on the scan electrode Y and the sustain electrode Z. Wall charges generated in a plasma discharge are accumulated on the upper dielectric layer 14.

The protective layer 16 prevents a damage of the upper dielectric layer 14 caused by sputtering generated in the plasma discharge, and increases secondary electron emission coefficient. The protective layer 16 is formed of Mg.

A lower dielectric layer 22 and barrier ribs 24 are formed on the address electrode X. A phosphor layer 25 is coated on the surface of the lower dielectric layer 22 and the surface of the barrier ribs 24.

The address electrode X is formed to intersect the scan electrode Y and the sustain electrode Z. The barrier ribs 24 are formed in parallel to the address electrode X, thereby preventing ultraviolet rays and visible light produced by a discharge from leaking into an adjacent discharge.

The phosphor layer 26 is excited by ultraviolet rays produced by the discharge such that any one visible light of red, green and blue is generated. A discharge space provided between the upper and lower substrates 12 and 18 and the barrier ribs 24 is with an inert gas.

The plasma display apparatus according to the first embodiment of the present invention is driven by dividing one frame into several subfields whose number of emissions are different from one another. Each of the subfields comprises a reset period, an address period and a sustain period.

In the reset period, wall charges are uniformly formed within the discharge cell. In the address period, a selective address discharge depending on a logical value of a video data is generated. In the sustain period, a discharge is maintained within a discharge cell selected by the generation of the address discharge.

In the plasma display apparatus thus driven, a high voltage of several hundreds of volt is required in the generation of the address discharge and the sustain discharge.

Accordingly, an energy recovery apparatus is used to lower a driving voltage required in the address discharge and a sustain discharge. The energy recovery apparatus recovers a voltage between the scan electrode Y and the sustain electrode Z such that the recovered voltage is used as a driving voltage in a next discharge.

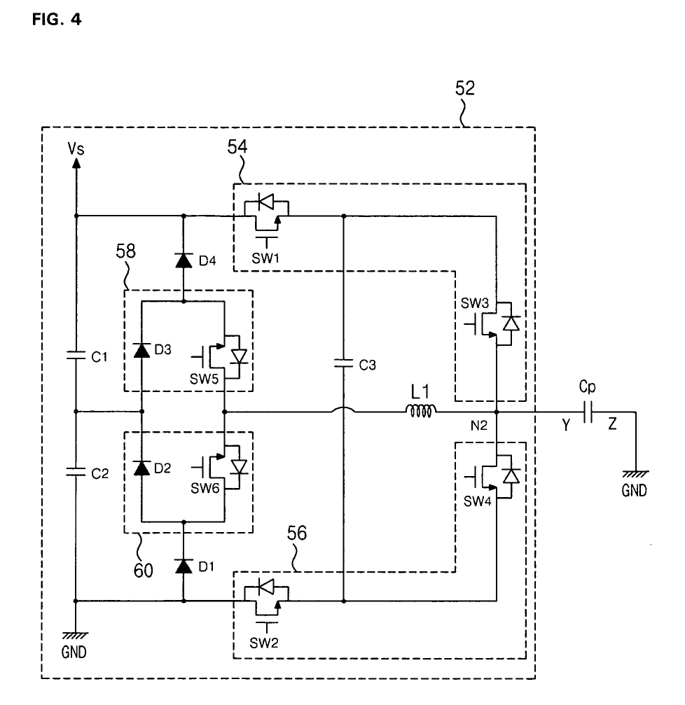

FIG. 4 is a circuit diagram of the plasma display apparatus according to the first embodiment of the present invention.

Referring to FIG. 4, an energy recovery apparatus 52 of the plasma display apparatus according to the first embodiment of the present invention has a symmetric structure across a panel capacitor Cp.

The panel capacitor Cp equivalently indicates a capacitance formed between the scan electrode Y and the sustain electrode Z of the PDP. An energy recovery apparatus, having a structure equal to a structure of the energy recovery apparatus 52 installed in the scan electrode Y of the panel capacitor Cp, is installed in the sustain electrode Z of the panel capacitor Cp.

The energy recovery apparatus 52 of the plasma display apparatus according to the first embodiment of the present invention comprises a first capacitor C1, a second capacitor C2, and a sustain voltage supply control unit 54. The first capacitor C1 and the second capacitor C2 are connected between a sustain voltage source (not shown) and a ground voltage source (not shown). The sustain voltage supply control unit 54 is connected between a common terminal of the sustain voltage source and the first capacitor C1, and the scan electrode Y of a panel capacitor Cp. The sustain voltage supply control unit 54 controls the supply of a sustain voltage Vs to the scan electrode Y of the panel capacitor Cp.

The energy recovery apparatus 52 further comprises a ground voltage supply control unit 56, an energy supply control unit 58 and an energy recovery control unit 60. The ground voltage supply control unit 56 is connected between the ground voltage source and the scan electrode Y of the panel capacitor Cp. The ground voltage supply control unit 56 controls the supply of a ground voltage level GND to the scan electrode Y of the panel capacitor Cp. The energy supply control unit 58 and the energy recovery control unit 60 are connected in parallel between a common terminal of the first capacitor C1 and the second capacitor C2 and the scan electrode Y of the panel capacitor Cp.

The energy recovery apparatus 52 further comprises a first inductor L1, a third capacitor C3, a first diode D1, and a fourth diode D4. The first inductor L1 is connected between a common terminal of the energy supply control unit 58 and the energy recovery control unit 60 and the scan electrode Y of the panel capacitor Cp. The third capacitor C3 is connected between the sustain voltage supply control unit 54 and the ground voltage supply control unit 56. The first diode D1 is connected between the ground voltage source and the energy recovery control unit 60. The fourth diode D4 is connected between the energy supply control unit 58 and the sustain voltage source.

The second capacitor C2 is an energy supply/recovery capacitor, and the third capacitor C3 is a maintenance capacitor.

The first capacitor C1 is connected between the sustain voltage source and the second capacitor C2, and divides the sustain voltage Vs. A voltage of Vs/2 being one half of a sustain voltage Vs supplied from the sustain voltage source is charged to the first capacitor C1.

The second capacitor C2 being the energy supply/recovery capacitor is connected between the first capacitor C1 and the ground voltage source. The second capacitor C2 recovers a reactive energy, which does not participate in a discharge of the PDP, from the PDP and again supplies the recovered energy to the scan electrode Y of the panel capacitor Cp. The voltage of Vs/2 being one half of the sustain voltage Vs is charged to the second capacitor C2.

The sustain voltage supply control unit 54 is connected between a common terminal of the sustain voltage source, the first capacitor C1 and the fourth diode D4, and the scan electrode Y of the panel capacitor Cp. The sustain voltage supply control unit 54 controls the supply of the sustain voltage Vs supplied from the sustain voltage source to the scan electrode Y of the panel capacitor Cp.

The sustain voltage supply control unit 54 comprises a first switch SW1 and a third switch SW3, which are connected in series between the sustain voltage source and the panel capacitor Cp.

The first switch SW1 is connected between the sustain voltage source and the third switch SW3. The first switch SW1 electrically connects the sustain voltage source, one terminal of the third switch SW3, and one terminal of the third capacitor C3 in response to a first switching control signal supplied from a timing controller (not shown).

As a result, a voltage of the panel capacitor Cp is maintained at the voltage of Vs/2 (that is, one half of the sustain voltage Vs) and the sustain voltage Vs. This will be described in detail below.

The third switch SW3 is connected between the first switch SW1 and the scan electrode Y of the panel capacitor Cp. A switching operation of the third switch SW3 supplies the sustain voltage Vs supplied to one terminal of the first switch SW1 to the scan electrode Y of the panel capacitor Cp in response to a third switching control signal supplied from the timing controller.

The ground voltage supply control unit 56 is connected between a common terminal of the ground voltage source, the second capacitor C2 and the first diode D1, and the scan electrode Y of the panel capacitor Cp. The ground voltage supply control unit 56 controls the supply of the ground voltage level GND supplied from the ground voltage source to the scan electrode Y of the panel capacitor Cp. The ground voltage supply control unit 56 comprises a second switch SW2 and a fourth switch SW4, which are connected in series between the ground voltage source and the scan electrode Y of the panel capacitor Cp.

The second switch SW2 is connected between the ground voltage source and the fourth switch SW4. The second switch SW2 electrically connects the ground voltage source to the other terminal of the third capacitor C3 and one terminal of the fourth switch SW4 in response to a second switching control signal supplied from the timing controller. As a result, the ground voltage level GND is supplied to the scan electrode Y of the panel capacitor Cp. This will be described in detail below.

The fourth switch SW4 is connected between the second switch SW2 and the scan electrode Y of the panel capacitor Cp. The fourth switch SW4 electrically connects a common terminal of one terminal of the second switch SW2 and the other terminal of the third capacitor C3 to the scan electrode Y of the panel capacitor Cp in response to a fourth switching control signal supplied from the timing controller.

As a result, a voltage of the panel capacitor Cp is maintained at the voltage of Vs/2 (that is, one half of the sustain voltage Vs) and the sustain voltage Vs. This will be described in detail below.

The energy supply control unit 58 is connected between the common terminal of the fist capacitor C1 and the second capacitor C2, and the fourth diode D4, the first inductor L1 and the energy recovery control unit 60. The energy supply control unit 58 controls the supply of energy stored in the second capacitor C2 to the scan electrode Y of the panel capacitor Cp.

The energy supply control unit 58 comprises a third diode D3 connected between the common terminal of the first capacitor C1 and the second capacitor C2 and the fourth diode D4, and a fifth switch SW5 connected between the fourth diode D4 and the first inductor L1.

The third diode D3 is connected between a common terminal of the first capacitor C1, the second capacitor C2 and the energy recovery control unit 60, and the fourth diode D4. The third diode D3 prevents an inverse current from the scan electrode Y of the panel capacitor Cp when supplying the energy from the second capacitor C2 to the scan electrode Y of the panel capacitor Cp.

Further, when a voltage of the panel capacitor Cp is maintained at a voltage of Vs/2, the third diode D3 prevents an inverse current from the scan electrode Y of the panel capacitor Cp.

The fifth switch SW5 is connected between a common terminal of the third diode D3 and the fourth diode D4, and a common terminal of the first inductor L1 and the energy recovery control unit 60. The fifth switch SW5 controls the supply of energy stored in the second capacitor C2 to the scan electrode Y of the panel capacitor Cp in response to a fifth switching control signal supplied from the timing controller.

The energy recovery control unit 60 is connected between the common terminal of the first capacitor C1 and the second capacitor C2, and a common terminal of the first diode D1, the first inductor L1 and the energy supply control unit 58. The energy recovery control unit 60 controls the supply of a reactive energy, which does not participate in the discharge in the panel capacitor Cp, to the second capacitor C2.

The energy recovery control unit 60 comprises a second diode D2 connected between the common terminal of the first capacitor C1 and the second capacitor C2 and the first diode D1, and a sixth switch SW6 connected between the first diode D1 and the first inductor L1.

The second diode D2 is connected between a common terminal of the first capacitor C1, the second capacitor C2 and the energy supply control unit 58, and the first diode D1. When recovering a reactive energy from the panel capacitor Cp and then supplying the recovered energy to the second capacitor C2, the second diode D2 prevents an inverse current from the second capacitor C2.

When the voltage of the panel capacitor Cp is maintained at the voltage of Vs/2, the second diode D2 prevents the inverse current from the second capacitor C2.

The sixth switch SW6 is connected between a common terminal of the first diode D1 and the second diode D2, and the common terminal of the first inductor L1 and the energy supply control unit 58. The sixth switch SW6 controls the supply of the reactive energy recovered from the panel capacitor Cp to the second capacitor C2 in response to a sixth switching control signal supplied from the timing controller.

The first inductor L1 is connected between the common terminal of the energy supply control unit 58 and the energy recovery control unit 60, and the scan electrode Y of the panel capacitor Cp. The first inductor L1 and the panel capacitor Cp form a resonance loop in response to switching operations of the fifth switch SW5 and the sixth switch SW6.

When the fifth switch SW5 is turned on, the energy stored in the second capacitor C2 is supplied to the scan electrode Y of the panel capacitor Cp by LC resonance of the first inductor L1 and the panel capacitor Cp. Further, when the sixth switch SW6 is turned on, the energy recovered from the panel capacitor Cp is supplied to the second capacitor C2 by LC resonance of the first inductor L1 and the panel capacitor Cp.

The third capacitor C3 being the maintenance capacitor is connected between the first switch SW1 and the second switch SW2. The voltage charge to the third capacitor C3 equals the voltage of Vs/2.

The fourth diode D4 is connected between a common terminal of the first capacitor C1, the sustain voltage source and the first switch SW1, and a common terminal of the third diode D3 and the fifth diode D5. The fourth diode D4 prevents an inverse current from the sustain voltage source.

As a result, loss of energy supplied from the second capacitor C2 to the scan electrode Y of the panel capacitor Cp is prevented.

The first diode D1 is connected between a common terminal of the second capacitor C2, the ground voltage source and the second switch SW2, and a common terminal of the second diode D2 and the sixth switch SW6. The first diode D1 prevents a loss of energy recovered from the scan electrode Y of the panel capacitor Cp to the second capacitor C2.

The first diode D1 and the fourth diode D4 may be removed.

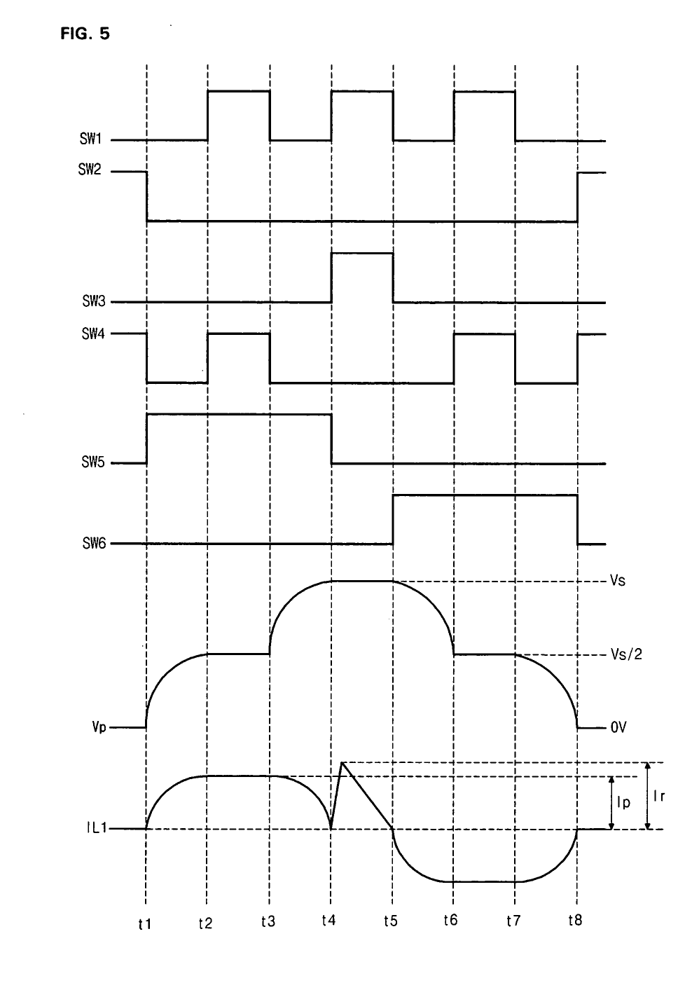

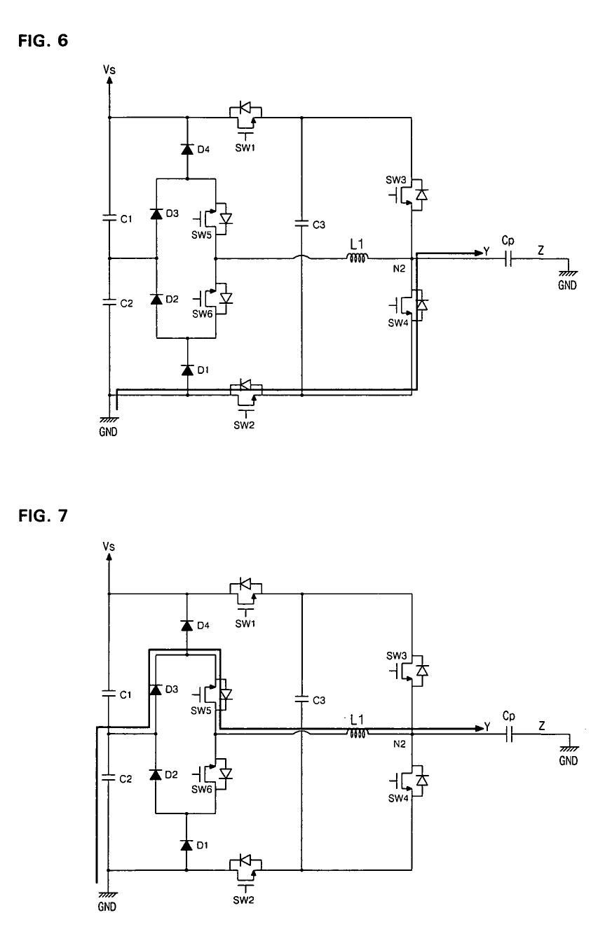

FIG. 5 is a timing chart of switches of the plasma display apparatus according to the first embodiment of the present invention. FIGS. 6 through 11 are circuit diagrams of a current path formed depending on on/off switching operations of the switches of FIG. 5. Suppose that the voltage of Vs/2 is charged to the first capacitor C1, the second capacitor C2 and the third capacitor C3.

Referring to FIGS. 5 through 11, before a time point t1, the second switch SW2 and the fourth switch SW4 are turned on in response to the second switching control signal of a high state and the fourth switching control signal of a high state supplied from the timing controller.

As a result, as illustrated in FIG. 6, a current path passing through the ground voltage source, the second switch SW2, the fourth switch SW4 and the scan electrode Y of the panel capacitor Cp is formed. Accordingly, the voltage of the panel capacitor Cp is maintained at the ground voltage level GND.

At the time point t1, the second switch SW2 and the fourth switch SW4 are turned off and the fifth switch SW5 is turned on in response to the second switching control signal of a low state, the fourth switching control signal of a low state, and the fifth switching control signal of a high state supplied from the timing controller.

As a result, as illustrated in FIG. 7, a current path passing through the second capacitor C2, the third diode D3, the fifth switch SW5, the first inductor L1 and the scan electrode Y of the panel capacitor Cp is formed, and the first inductor L1 and the panel capacitor Cp generate serial resonance. At this time, a voltage Vp of the panel capacitor Cp and a current IL1 flowing in the first inductor L1 are expressed by the following Equation 5.

$${V}_{p} ( t ) = \frac{{V}_{s}}{2} ( 1 - cos {w}_{n} t ) , \\ IL 1 ( t ) = \frac{{V}_{s}}{2 {Z}_{n}} sin {w}_{n} t \\ Here , \\ {w}_{n} = \frac{1}{\sqrt{{L}_{1} {C}_{p}}} , \\ {z}_{n} = \sqrt{\frac{{L}_{1}}{{C}_{p}}} . \qquad [ Equation 5 ]$$

Accordingly, at the time point t1, the voltage Vp of the panel capacitor Cp rises from the ground voltage level (that is, 0V) to the voltage of Vs/2, and the current IL1 flowing in the first inductor L1 rises to Vₛ/2Zₙ.

At a time point t2, the first switch SW1 and the fourth switch SW4 are turned on and the fifth switch SW5 remains in a turn-on state at the time point t1 in response to the first switching control signal of a high state, the fourth switching control signal of a high state, and the fifth switching control signal of the high state supplied from the timing controller.

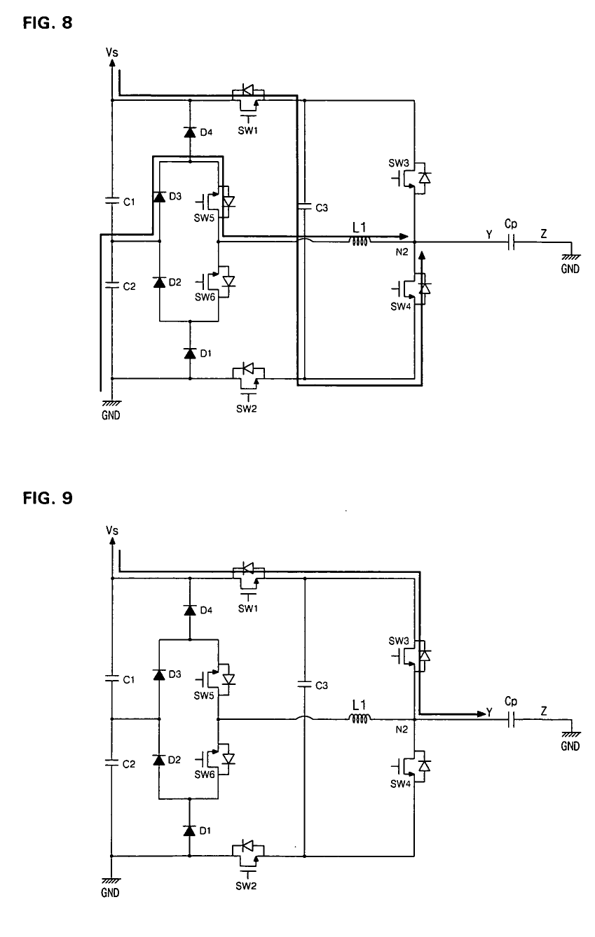

As a result, as illustrated in FIG. 8, a first current path passing through the second capacitor C2, the third diode D3, the fifth switch SW5, the first inductor L1 and the scan electrode Y of the panel capacitor Cp, and a second current path passing through the sustain voltage source, the first switch SW1, the third capacitor C3, the fourth switch SW4, and the scan electrode Y of the panel capacitor Cp are formed.

Accordingly, the voltage Vp of the panel capacitor Cp is maintained at the voltage of Vs/2. Since a voltage between both terminals of the first inductor L1 is 0V, the current IL1 of the first inductor L1 is maintained at a value of Vₛ/2Zₙ.

At a time point t3, the first switch SW1 and the fourth switch SW4 are turned off and the fifth switch SW5 remains in a turn-on state at the time point t2 in response to the first switching control signal of a low state, the fourth switching control signal of the low state, and the fifth switching control signal of the high state supplied from the timing controller.

As a result, as illustrated in FIG. 7, a current path passing through the second capacitor C2, the third diode D3, the fifth switch SW5, the first inductor L1 and the scan electrode Y of the panel capacitor Cp is formed, and the first inductor L1 and the panel capacitor Cp generate serial resonance. At this time, the voltage Vp of the panel capacitor Cp and the current IL1 flowing in the first inductor L1 are expressed by the following Equation 6.

$${V}_{p} ( t ) = \frac{{V}_{s}}{2} ( 1 + sin {w}_{n} t ) , \\ IL 1 ( t ) = \frac{{V}_{s}}{2 {Z}_{n}} cos {w}_{n} t \qquad [ Equation 6 ]$$

Accordingly, at the time point t3, the voltage Vp of the panel capacitor Cp rises from the voltage of Vs/2 to the sustain voltage Vs, and the current IL1 of the first inductor L1 falls from Vₛ/2Zₙ to 0.

At a time point t4, the first switch SW1 and the third switch SW3 are turned on and the fifth switch SW5 is turned off in response to the first switching control signal of the high state, the third switching control signal of a high state, and the fifth switching control signal of the low state supplied from the timing controller.

As a result, as illustrated in FIG. 9, a current path passing through the first switch SW1, the third switch SW3 and the scan electrode Y of the panel capacitor Cp is formed. Accordingly, the voltage Vp of the panel capacitor Cp is maintained at the sustain voltage Vs.

At a time point t5, the first switch SW1 and the third switch SW3 are turned off and the sixth switch SW6 is turned on in response to the first switching control signal of the low state, the third switching control signal of a low state, and the sixth switching control signal of a high state supplied from the timing controller.

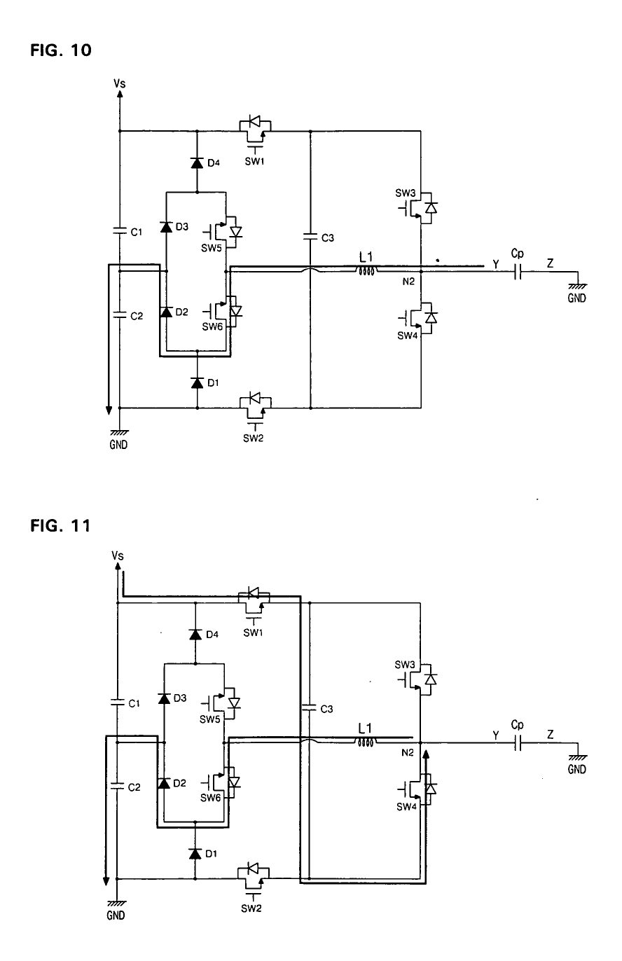

As a result, as illustrated in FIG. 10, a current path passing through the panel capacitor Cp, the first inductor L1, the sixth switch SW6, the second diode D2, and the second capacitor C2 is formed, and the first inductor L1 and the panel capacitor Cp generate serial resonance. At this time, the voltage Vp of the panel capacitor Cp and the current IL1 flowing in the first inductor L1 are expressed by the following Equation 7.

$${V}_{p} ( t ) = \frac{{V}_{s}}{2} ( 1 + cos {w}_{n} t ) , \\ IL 1 ( t ) = - \frac{{V}_{s}}{2 {Z}_{n}} sin {w}_{n} t \qquad [ Equation 7 ]$$

Accordingly, at the time point t5, the voltage Vp of the panel capacitor Cp falls from the sustain voltage Vs to the voltage of Vs/2, and the current IL1 of the first inductor L1 falls from 0 to −(Vₛ/2Zₙ).

At a time point t6, the first switch SW1 and the fourth switch SW4 are turned on and the sixth switch SW6 remains in a turn-on state at the time point t5 in response to the first switching control signal of the high state, the fourth switching control signal of the high state, and the sixth switching control signal of the high state supplied from the timing controller.

As a result, as illustrated in FIG. 11, a first current path passing through the panel capacitor Cp, the first inductor L1, the sixth switch SW6, the second diode D2 and the second capacitor C2, and a second current path passing through the sustain voltage source, the first switch SW1, the third capacitor C3, the fourth switch SW4, and the scan electrode Y of the panel capacitor Cp are formed.

Accordingly, the voltage Vp of the panel capacitor Cp is maintained at the voltage of Vs/2. Since the voltage between both terminals of the first inductor L1 is 0V, the current IL1 of the first inductor L1 is maintained at a value of −(Vₛ/2Zₙ).

At a time point t7, the first switch SW1 and the fourth switch SW4 are turned off and the sixth switch SW6 remains in a turn-on state at the time point t6 in response to the first switching control signal of the low state, the fourth switching control signal of the low state, and the sixth switching control signal of the high state supplied from the timing controller.

As a result, as illustrated in FIG. 10, a current path passing through the panel capacitor Cp, the first inductor L1, the sixth switch SW6, the second diode D2, and the second capacitor C2 is formed, and the first inductor L1 and the panel capacitor Cp generate serial resonance. At this time, the voltage Vp of the panel capacitor Cp and the current L1 flowing in the first inductor L1 are expressed by the following Equation 8.

$${V}_{p} ( t ) = \frac{{V}_{s}}{2} ( 1 - sin {w}_{n} t ) , \\ IL 1 ( t ) = - \frac{{V}_{s}}{2 {Z}_{n}} cos {w}_{n} t \qquad [ Equation 8 ]$$

Accordingly, at the time point t7, the voltage Vp of the panel capacitor Cp falls from the voltage of Vs/2 to the ground voltage level (that is, 0V), and the current IL1 of the first inductor L1 rises from −(Vₛ/2Zₙ₎ to 0.

While the switching operations of the time points t1 to t7 are repeatedly performed at and after a time point t8, a sustain pulse is supplied to the scan electrode Y of the panel capacitor Cp.

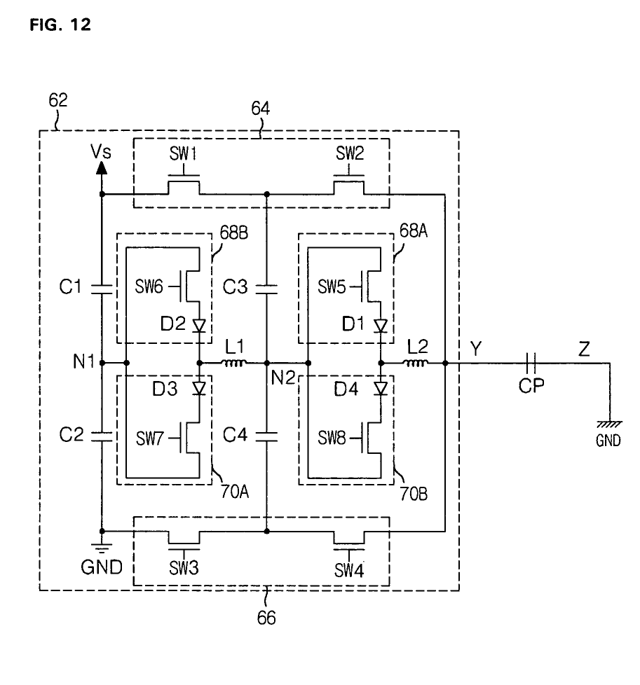

FIG. 12 is a circuit diagram of the plasma display apparatus according to a second embodiment of the present invention.

Referring to FIG. 12, an energy recovery apparatus 62 of a plasma display apparatus according to a second embodiment of the present invention has a symmetric structure across a panel capacitor Cp.

The panel capacitor Cp equivalently indicates a capacitance formed between a scan electrode Y and a sustain electrode Z of a PDP. An energy recovery apparatus, having a structure equal to a structure of the energy recovery apparatus 62 installed in the scan electrode Y of the panel capacitor Cp, is installed in the sustain electrode Z of the panel capacitor Cp.

The energy recovery apparatus 62 of the plasma display apparatus according to the second embodiment of the present invention comprises the panel capacitor Cp, a sustain voltage source (not shown) for supplying a sustain voltage Vs, first and second capacitors C1 and C2 connected in series between the sustain voltage source and a ground voltage source (not shown), a first node N1 formed between the first capacitor C1 and the second capacitor C2, a sustain voltage supply control unit 64 connected between the sustain voltage source and the panel capacitor Cp.

The energy recovery apparatus 62 further comprises a ground voltage supply control unit 66, third and fourth capacitors C3 and C4, a second node N2, a first inductor L1, a first energy recovery control unit 70A, a second energy supply control unit 68B, a second inductor L2, a first energy supply control unit 68A, and a second energy recovery control unit 70B. The ground voltage supply control unit 66 is connected between the ground voltage source and the panel capacitor Cp. The third capacitor C3 and the fourth capacitor C4 are connected in series between the sustain voltage supply control unit 64 and the ground voltage supply control unit 66. The second node N2 is formed between the third capacitor C3 and the fourth capacitor C4. The first inductor L1 is connected between the first node N1 and the second node N2. The first energy recovery control unit 70A and the second energy supply control unit 68B are connected in parallel between the first node N1 and the first inductor L1. The second inductor L2 is connected between the second node N2 and the scan electrode Y of the panel capacitor Cp. The first energy supply control unit 68A and the second energy recovery control unit 70B are connected in parallel between the second node N2 and the second inductor L2.

The second capacitor C2 and the fourth capacitor C4 are an energy supply/recovery capacitor, and the third capacitor C3 is a maintenance capacitor.

The first capacitor C1 is connected between the sustain voltage source and the second capacitor C2, and divides the sustain voltage Vs. A voltage of Vs/2 being one half of the sustain voltage Vs supplied from the sustain voltage source is charged to the first capacitor C1.

The second capacitor C2 being the energy supply/recovery capacitor is connected between the first capacitor C1 and the ground voltage source. The second capacitor C2 recovers a reactive energy, which does not participate in a discharge in the PDP, and again supplies the recovered energy to the scan electrode Y of the panel capacitor Cp. The voltage of Vs/2 being one half of the sustain voltage Vs is charged to the second capacitor C2.

The sustain voltage supply control unit 64 is connected between the sustain voltage source, the first capacitor C1 and the third capacitor C3, and the scan electrode Y of the panel capacitor Cp. The sustain voltage supply control unit 64 controls the supply of the sustain voltage Vs supplied from the sustain voltage source to the scan electrode Y of the panel capacitor Cp.

The sustain voltage supply control unit 64 comprises a first switch SW1 and a second switch SW2, which are connected in series between the sustain voltage source and the panel capacitor Cp.

The first switch SW1 is connected between a common terminal of the first capacitor C1 and the sustain voltage source, and a common terminal of the third capacitor C3 and the second switch SW2. The first switch SW1 electrically connects the sustain voltage source, one terminal of the second switch SW2, and one terminal of the third capacitor C3 in response to a first switching control signal supplied from a timing controller (not shown).

As a result, a voltage of the panel capacitor Cp is maintained at the voltage of Vs/2 (that is, one half of the sustain voltage Vs) and the sustain voltage Vs. This will be described in detail below.

The second switch SW2 is connected between the first switch SW1 and the scan electrode Y of the panel capacitor Cp. A switching operation of the second switch SW2 supplies the sustain voltage Vs supplied to one terminal of the first switch SW1 to the scan electrode Y of the panel capacitor Cp in response to a second switching control signal supplied from the timing controller.

The ground voltage supply control unit 66 is connected between the ground voltage source, the second capacitor C2 and the fourth capacitor C4, and the scan electrode Y of the panel capacitor Cp. The ground voltage supply control unit 66 controls the supply of the ground voltage level GND to the scan electrode Y of the panel capacitor Cp.

The ground voltage supply control unit 66 comprises a third switch SW3 and a fourth switch SW4, which are connected in series between the ground voltage source and the scan electrode Y of the panel capacitor Cp.

The third switch SW3 is connected between a common terminal of the second capacitor C2 and the ground voltage source, and a common terminal of the fourth capacitor C4 and the fourth switch SW4. The third switch SW3 electrically connects the ground voltage source to one terminal of the fourth capacitor C4 and one terminal of the fourth switch SW4 in response to a third switching control signal supplied from the timing controller. As a result, the ground voltage level GND is supplied to the scan electrode Y of the panel capacitor Cp. This will be described in detail below.

The fourth switch SW4 is connected between the third switch SW3 and the scan electrode Y of the panel capacitor Cp. The fourth switch SW4 electrically connects a common terminal of one terminal of the third switch SW3 and one terminal of the fourth capacitor C4 to the scan electrode Y of the panel capacitor Cp in response to a fourth switching control signal supplied from the timing controller. As a result, a voltage of the panel capacitor Cp is maintained at the voltage of Vs/2 (that is, one half of the sustain voltage Vs) and the ground voltage level GND. This will be described in detail below.

The first energy supply control unit 68A is connected between the second node N2 and the second inductor L2. The first energy supply control unit 68A controls the supply of energy stored in the fourth capacitor C4 to the scan electrode Y of the panel capacitor Cp.

The first energy supply control unit 68A comprises a fifth switch SW5 and a first diode D1, which are connected between the second node N2 and the second inductor L2. The first energy supply control unit 68A supplies a voltage of Vs/4 (that is, one quarter of the sustain voltage Vs) stored in the fourth capacitor C4 to the scan electrode Y of the panel capacitor Cp.

The fifth switch SW5 controls the supply of energy stored in the fourth capacitor C4 to the scan electrode Y of the panel capacitor Cp in response to a fifth switching control signal supplied from the timing controller.

When recovering the energy from the panel capacitor Cp, the first diode D1 prevents the recovered energy from flowing in the fifth switch SW5.

The second energy supply control unit 68B is connected between the first node N1 and the first inductor L1. The second energy supply control unit 68B controls the supply of the energy stored in the second capacitor C2 to the scan electrode Y of the panel capacitor Cp.

The second energy supply control unit 68B comprises a sixth switch SW6 and a second diode D2, which are connected between the first node N1 and the first inductor L1.

The second energy supply control unit 68B rises the voltage of the panel capacitor Cp, which equals the voltage of Vs/2 by the first energy supply control unit 68A, to approximately the sustain voltage Vs.

The sixth switch SW6 controls the supply of energy stored in the second capacitor C2 to the scan electrode Y of the panel capacitor Cp in response to a sixth switching control signal supplied from the timing controller.

When recovering the energy from the panel capacitor Cp, the second diode D2 prevents the recovered energy from flowing in the sixth switch SW6.

The first energy recovery control unit 70A is connected between the first node N1 and the first inductor L1. The first energy recovery control unit 70A controls the supply of a reactive energy, which does not participate in the discharge in the panel capacitor Cp, to the second capacitor C2. The first energy recovery control unit 70A comprises a seventh switch SW7 and a third diode D3, which are connected between the first node N1 and the first inductor L1.

The seventh switch SW7 controls the supply of the reactive energy recovered from the panel capacitor Cp to the second capacitor C2 in response to a seventh switching control signal supplied from the timing controller.

When recovering the reactive energy from the panel capacitor Cp and then supplying the reactive energy to the second capacitor C2, the third diode D3 prevents an inverse current from the second capacitor C2.

The second energy recovery control unit 70B is connected between the second node N2 and the second inductor L2. The second energy recovery control unit 70B controls the supply of the reactive energy recovered from the panel capacitor Cp to the fourth capacitor C4.

The second energy recovery control unit 70B comprises an eighth switch SW8 and the fourth diode D4, which are connected between the second node N2 and the second inductor L2.

The eighth switch SW8 controls the supply of the reactive energy, which does not participate in the discharge in the panel capacitor Cp, to the fourth capacitor C4 in response to an eighth switching control signal supplied from the timing controller.

When recovering the reactive energy, which does not participate in the discharge in the panel capacitor Cp, from the panel capacitor Cp and supplying the reactive energy to the fourth capacitor C4, the fourth diode D4 prevents an inverse current from the fourth capacitor C4.

The first inductor L1 and the panel capacitor Cp form a resonance loop in response to switching operations of the sixth switch SW6 and the seventh switch SW7, which are connected between the first node N1 and the second node N2.

When the sixth switch SW6 is turned on, the energy stored in the second capacitor C2 is supplied to the scan electrode Y of the panel capacitor Cp by LC resonance of the first inductor L1 and the panel capacitor Cp. Further, when the seventh switch SW7 is turned on, the energy recovered from the panel capacitor Cp is supplied to the second capacitor C2 by LC resonance of the first inductor L1 and the panel capacitor Cp.

The second inductor L2 and the panel capacitor Cp form a resonance loop in response to switching operations of the fifth switch SW5 and the eighth switch SW8, which are connected between the second node N2 and the scan electrode Y of the panel capacitor Cp.

When the fifth switch SW5 is turned on, the energy stored in the fourth capacitor C4 is supplied to the scan electrode Y of the panel capacitor Cp by LC resonance of the second inductor L2 and the panel capacitor Cp. Further, when the eighth switch SW8 is turned on, the energy recovered from the panel capacitor Cp is supplied to the fourth capacitor C4 by LC resonance of the second inductor L2 and the panel capacitor Cp. The first capacitor C1 may be removed.

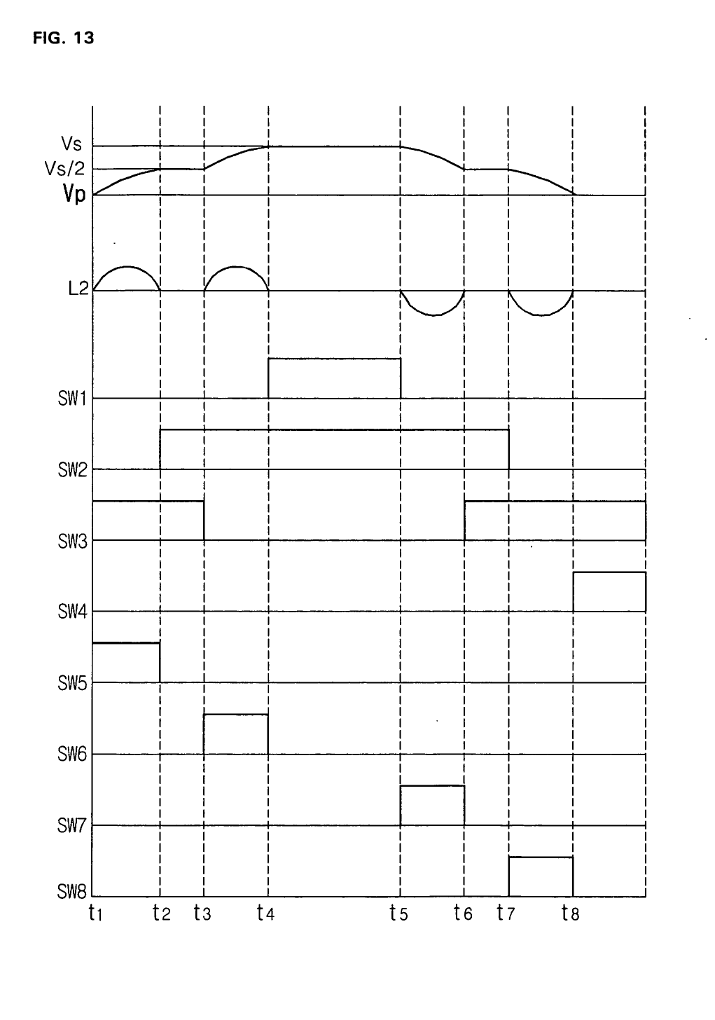

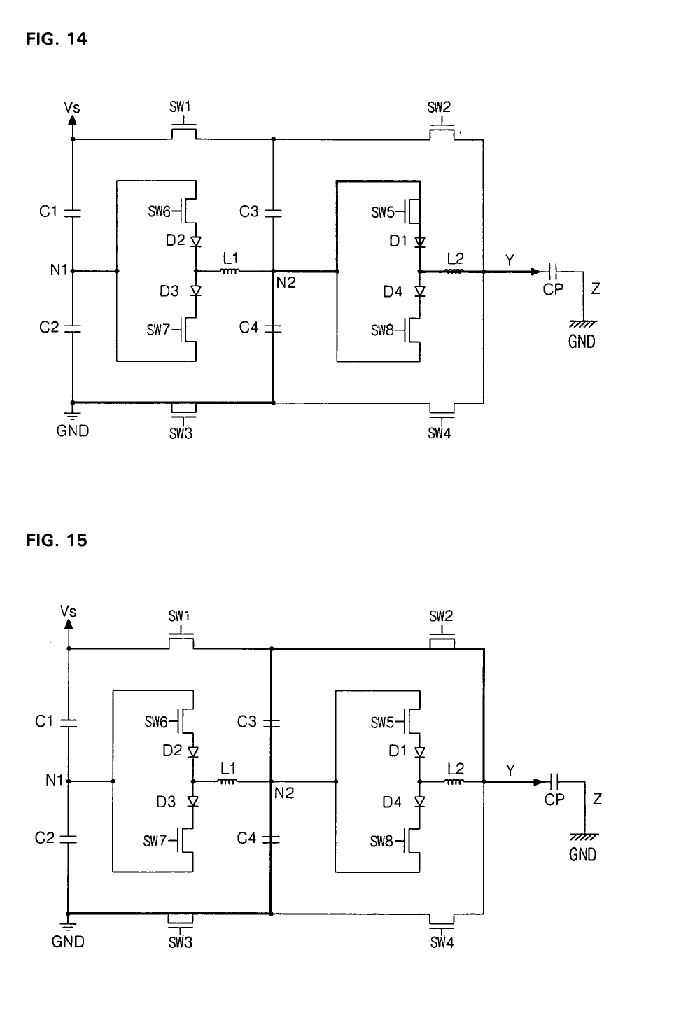

FIG. 13 is a timing chart of switches of the plasma display apparatus according to the second embodiment of the present invention. FIGS. 14 through 21 are circuit diagrams of a current path formed depending on on/off switching operations of the switches of FIG. 13.

Suppose that a voltage between both terminals of each of the first and second capacitors C1 and C2 is set to the voltage of Vs/2, and a voltage between both terminals of each of the third and fourth capacitors C3 and C4 is set to the voltage of Vs/4 being one quarter of the sustain voltage Vs.

Referring to FIGS. 13 through 21, at a time point t1, the third switch SW3 and the fifth switch SW5 is turned on in response to the third switching control signal of a high state and the fifth switching control signal of a high state supplied from the timing controller.

As a result, as illustrated in FIG. 14, a current path passing through the third switch SW3, the fourth capacitor C4, the second node N2, the fifth switch SW5, the first diode D1, the second inductor L2, and the scan electrode Y of the panel capacitor Cp is formed, and the second inductor L2 and the panel capacitor Cp generate serial resonance. At this time, a voltage Vp of the panel capacitor Cp and a current Ip2(t) flowing in the second inductor L2 are expressed by the following Equation 9.

$${V}_{p} ( t ) = \frac{Vs}{4} ( 1 - {ⅇ}^{- ζ {ω}_{n} t} cos {ω}_{d} t - \frac{ζ {ⅇ}^{- ζ {ω}_{n} t}}{\sqrt{1 - {ζ}^{2}}} sin {ω}_{d} t ) \\ {i}_{p 2} ( t ) = \frac{Vs {ⅇ}^{- ζ {ω}_{n} t}}{4 L {ω}_{d}} sin {ω}_{d} t \\ Here , {ω}_{n} = \frac{1}{\sqrt{{LC}_{p}}} , ζ = {R}_{eq} \sqrt{\frac{{C}_{P}}{L}} , {ω}_{d} = {ω}_{n} \sqrt{1 - {ζ}^{2}} . \qquad [ Equation 9 ]$$

Req indicates the total of parasitic resonances shown in the current path. Accordingly, the tine point t1, the voltage Vp of the panel capacitor Cp rises from the ground voltage level (that is, 0V) to the voltage Vs/2.

At a time point t2, the second switch SW2 is turned on and the third switch SW3 remains in a turn-on state at the time point t1 in response to the second switching control signal of a high state and the third switching control signal of a high state supplied from the timing controller.

As a result, as illustrated in FIG. 15, a current path passing through the third switch SW3, the fourth capacitor C4, the third capacitor C3, the second switch SW2, and the scan electrode Y of the panel capacitor Cp is formed. Accordingly, the voltage Vp of the panel capacitor Cp is maintained at the voltage of Vs/2.

At a time point t3, the third switch SW3 is turned off. Further, the second switch SW2 and the sixth switch SW6 are turned on in response to the second switching control signal of a high state and the sixth switching control signal of a high state supplied from the timing controller.

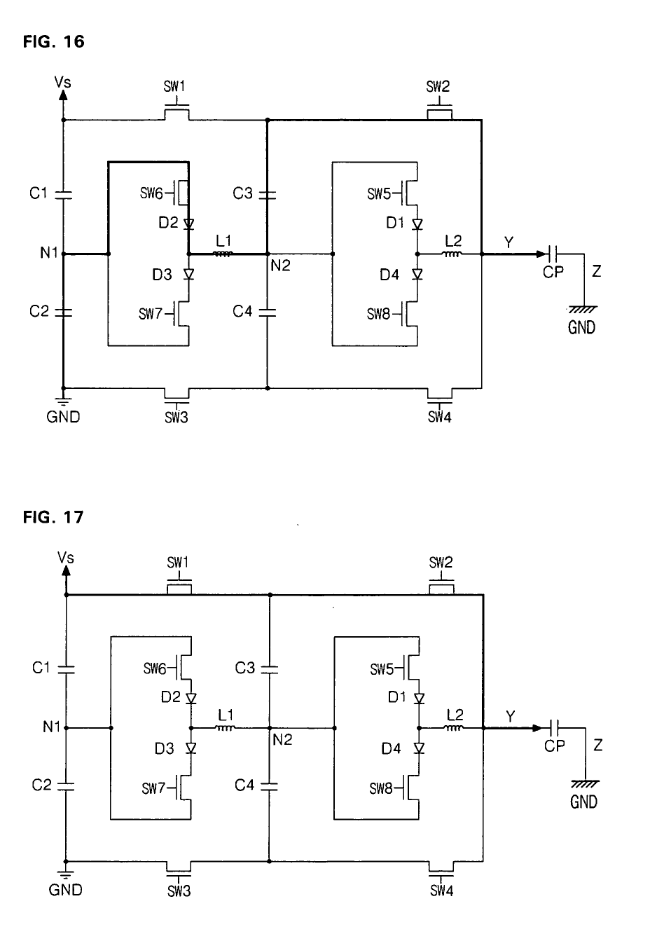

As a result, as illustrated in FIG. 16, a current path passing through the second capacitor C2, the first node N1, the sixth switch SW6, the second diode D2, the first inductor L1, the second switch SW2, and the scan electrode Y of the panel capacitor Cp is formed, and the first inductor L1 and the panel capacitor Cp generate serial resonance. At this time, the voltage Vp of the panel capacitor Cp and a current ip1(t) flowing in the first inductor L1 are expressed by the following Equation 10.

$${V}_{p} ( t ) = \frac{3 Vs}{4} ( 1 - {ⅇ}^{- ζ {ω}_{n} t} cos {ω}_{d} t - \frac{ζ {ⅇ}^{- ζ {ω}_{n} t}}{\sqrt{1 - {ζ}^{2}}} sin {ω}_{d} t ) \\ {i}_{p 1} ( t ) = \frac{Vs {ⅇ}^{- ζ {ω}_{n} t}}{4 L {ω}_{d}} sin {ω}_{d} t \qquad [ Equation 10 ]$$

Accordingly, the voltage Vp of the panel capacitor Cp rises from the voltage of Vs/2 to a voltage close to the sustain voltage Vs.

At a time point t4, the first switch SW1 and the second switch SW2 are turned on in response to the first switching control signal of a high state and the second switching control signal of the high state supplied from the timing controller.

As a result, as illustrated in FIG. 17, a current path passing through the sustain voltage source, the first switch SW1, the second switch SW2 and the scan electrode Y of the panel capacitor Cp is formed. Accordingly, the voltage Vp of the panel capacitor Cp is maintained at the sustain voltage Vs.

At a time point t5, the second switch SW2 and the seventh switch SW7 are turned on in response to the second switching control signal of the high state and the seventh switching control signal of a high state supplied from the timing controller.

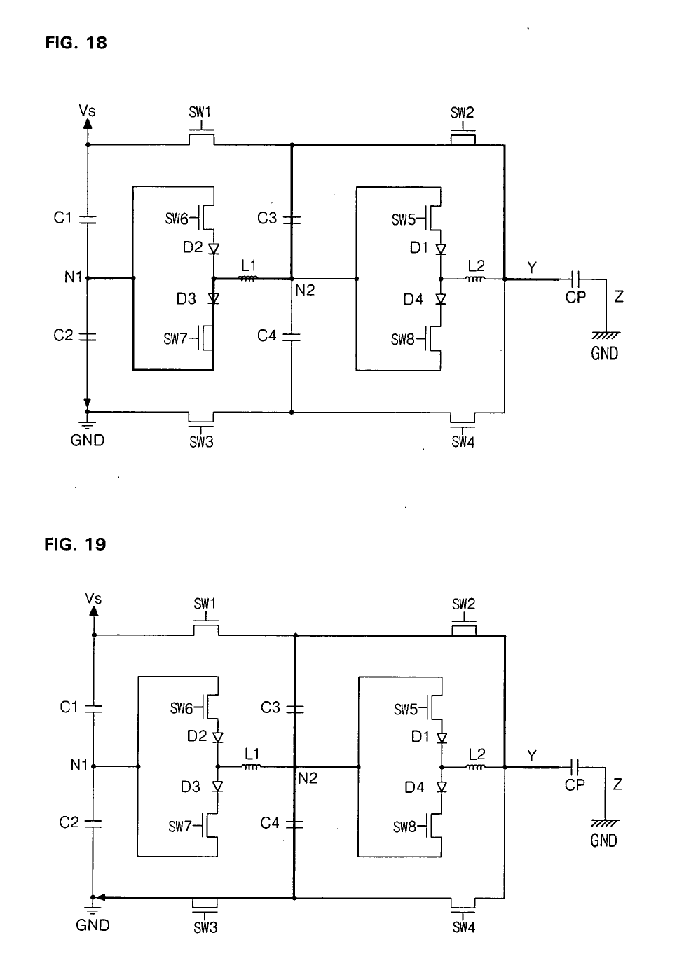

As a result, as illustrated in FIG. 18, a current path passing through the scan electrode Y of the panel capacitor Cp, the second switch SW2, the third capacitor C3, the first inductor L1, the third diode D3, the seventh switch SW7 and the second capacitor C2 is formed, and the first inductor L1 and the panel capacitor Cp generate serial resonance. At this time, the voltage Vp of the panel capacitor Cp and a current ip1(t) flowing in the first inductor L1 are expressed by the following Equation 11.

$${V}_{p} ( t ) = \frac{3 Vs}{4} ( 1 + {ⅇ}^{- ζ {ω}_{n} t} cos {ω}_{d} t + \frac{ζ {ⅇ}^{- ζ {ω}_{n} t}}{\sqrt{1 - {ζ}^{2}}} sin {ω}_{d} t ) \\ {i}_{p 1} ( t ) = - \frac{Vs {ⅇ}^{- ζ {ω}_{n} t}}{4 L {ω}_{d}} sin {ω}_{d} t \qquad [ Equation 11 ]$$

Accordingly, the voltage Vp of the panel capacitor Cp falls to the voltage of Vs/2, and the energy recovered from the panel capacitor Cp is stored in the second capacitor C2.

At a time point t6, the second switch SW2 and the third switch SW3 are turned on in response to the second switching control signal of the high state and the third switching control signal of the high state supplied from the timing controller.

As a result, as illustrated in FIG. 19, a current path passing through the scan electrode Y of the panel capacitor Cp, the second switch SW2, the third capacitor C3, the fourth capacitor C3, and the third switch SW3 is formed. Accordingly, the voltage Vp of the panel capacitor Cp is maintained at the voltage of Vs/2.

At a time point t7, the second switch SW2 is turned off. Further, the third switch SW3 and the eighth switch SW8 are turned on in response to the third switching control signal of the high state and the eighth switching control signal of a high state supplied from the timing controller.

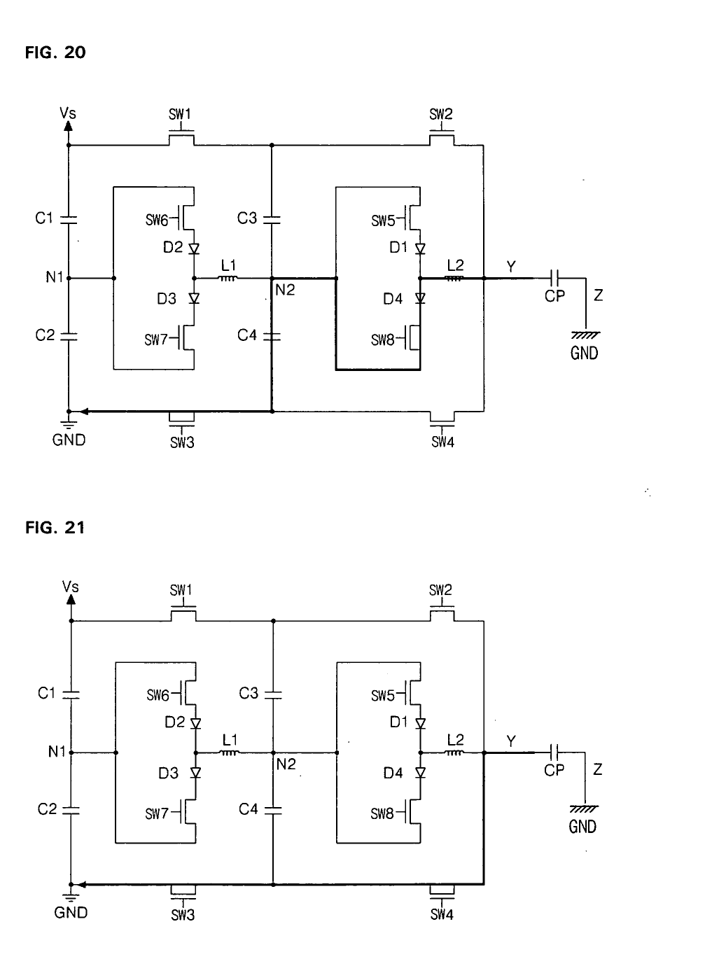

As a result, as illustrated in FIG. 20, a current path passing through the scan electrode Y of the panel capacitor Cp, the second inductor L2, the fourth diode D4, the eighth switch SW8, the second node N2, the fourth capacitor C4, and the third switch SW3 is formed, and the second inductor L2 and the panel capacitor Cp generate serial resonance. At this time, the voltage Vp of the panel capacitor Cp and a current ip2(t) flowing in the second inductor L2 are expressed by the following Equation 12.

$${V}_{p} ( t ) = \frac{Vs}{4} ( 1 + {ⅇ}^{- ζ {ω}_{n} t} cos {ω}_{d} t + \frac{ζ {ⅇ}^{- ζ {ω}_{n} t}}{\sqrt{1 - {ζ}^{2}}} sin {ω}_{d} t ) \\ {i}_{p 2} ( t ) = - \frac{Vs {ⅇ}^{- ζ {ω}_{n} t}}{4 L {ω}_{d}} sin {ω}_{d} t \qquad [ Equation 12 ]$$

Accordingly, the voltage Vp of the panel capacitor Cp falls from the voltage of Vs/2 to the ground voltage level (tat is, 0V). The energy recovered from the panel capacitor Cp is stored in the capacitor C4.

At a time point t8, the third switch SW3 and the fourth switch SW4 are turned on in response to the third switching control signal of the high state and the fourth switching control signal of the high state supplied from the timing controller.

As a result, as illustrated in FIG. 21, a current path passing through the ground voltage source, the fourth switch SW4, the third switch SW3, and the scan electrode Y of the panel capacitor Cp is formed. Accordingly, the voltage Vp of the panel capacitor Cp is maintained at the ground voltage level GND.

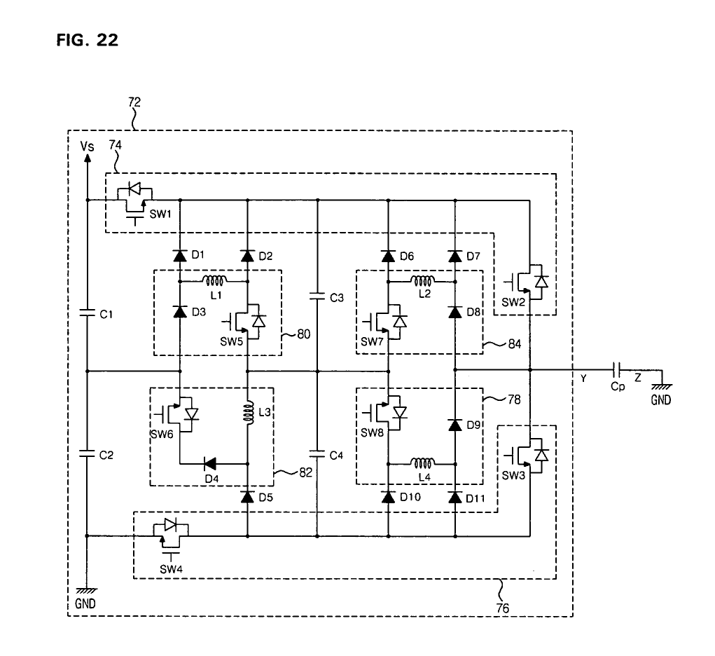

FIG. 22 is a circuit diagram of the plasma display apparatus according to a third embodiment of the present invention.

Referring to FIG. 22, an energy recovery apparatus 72 of a plasma display apparatus according to a third embodiment of the present invention has a symmetric structure across a panel capacitor Cp.

The panel capacitor Cp equivalently indicates a capacitance formed between a scan electrode Y and a sustain electrode Z of a PDP. An energy recovery apparatus, having a structure equal to a structure of the energy recovery apparatus 72 installed in the scan electrode Y of the panel capacitor Cp, is installed in the sustain electrode Z of the panel capacitor Cp.

The energy recovery apparatus 72 of the plasma display apparatus according to the third embodiment of the present invention comprises first and second capacitors C1 and C2 connected in series between a sustain voltage source (not shown) and a ground voltage source (not shown), and a sustain voltage supply control unit 74 connected between the sustain voltage source and the scan electrode Y of the panel capacitor Cp.

The energy recovery apparatus 72 further comprises a ground voltage supply control unit 76, third and fourth capacitors C3 and C4, a second energy supply control unit 80, a first energy recovery control unit 82, a first energy supply control unit 78, and a second energy recovery control unit 84. The ground voltage supply control unit 76 is connected between the ground voltage source and the scan electrode Y of the panel capacitor Cp. The third capacitor C3 and the fourth capacitor C4 are connected in series between the sustain voltage supply control unit 74 and the ground voltage supply control unit 76. The second energy supply control unit 80 and the first energy recovery control unit 82 are connected in parallel between a common terminal of the first and second capacitors C1 and C2 and a common terminal of the third and fourth capacitors C3 and C4. The first energy supply control unit 78 and the second energy recovery control unit 84 are connected between the common terminal of the third and fourth capacitors C3 and C4 and the scan electrode Y of the panel capacitor Cp.

The energy recovery apparatus 72 further comprises a first diode D1 and a second diode D2 which are connected in parallel between the sustain voltage supply control unit 74 and the second energy supply control unit 80.

The energy recovery apparatus 72 further comprises a sixth diode D6, a seventh diode D7, a fifth diode D5, a tenth diode D10, and an eleventh diode D11. The sixth diode D6 and the seventh diode D7 are connected in parallel between the sustain voltage supply control unit 74 and the second energy recovery control unit 84. The fifth diode D5 is connected between the ground voltage supply control unit 76 and the first energy recovery control unit 82. The tenth diode D10 and the eleventh diode D11 are connected in parallel between the ground voltage supply control unit 76 and the first energy supply control unit 78.

The first capacitor C1 is connected between the sustain voltage source and the second capacitor C2. The first capacitor C1 and the second capacitor C2 divide the sustain voltage Vs. The voltage charge to the first capacitor C1 equals a voltage of Vs/2 being one half of the sustain voltage Vs supplied from the sustain voltage source.

The second capacitor C2 is connected between the first capacitor C1 and the ground voltage source. The second capacitor C2 recovers a reactive energy, which does not participate in a discharge in the PDP, from the PDP, and again supplies the recovered energy to the scan electrode Y of the panel capacitor Cp. The voltage charge to the second capacitor C2 equals to the voltage of Vs/2 being one half of the sustain voltage Vs.

The sustain voltage supply control unit 74 is connected between a common terminal of the sustain voltage source and the first capacitor C1, and the scan electrode Y of the panel capacitor Cp. The sustain voltage supply control unit 74 controls the supply of the sustain voltage Vs supplied from the sustain voltage source to the scan electrode Y of the panel capacitor Cp.

The sustain voltage supply control unit 74 comprises a first switch SW1 and a second switch SW2, which are connected in series between the sustain voltage source and the panel capacitor Cp.

The first switch SW1 is connected between the sustain voltage source and the second switch SW2. The first switch SW1 controls the supply of the sustain voltage Vs stored in the first and second capacitors C1 and C2 or the sustain voltage Vs supplied from the sustain voltage source to one terminal of the second switch SW2, in response to a first switching control signal supplied from a timing controller (not shown).

As a result, when the second switch SW2 is turned on in response to a second switching control signal supplied from the timing controller, the sustain voltage Vs is supplied to the scan electrode Y of the panel capacitor Cp.

The second switch SW2 is connected between the first switch SW1 and the scan electrode Y of the panel capacitor Cp. The second switch SW2 controls the supply of the sustain voltage Vs and the voltage of Vs/2 supplied to one terminal of the second switch SW2 to the scan electrode Y of the panel capacitor Cp in response to the second switching control signal. As a result, when the second switch SW2 is turned on, a voltage of the panel capacitor Cp is maintained at the voltage of Vs/2 and the sustain voltage Vs.

The ground voltage supply control unit 76 is connected between a common terminal of the ground voltage source and the second capacitor C2, and the scan electrode Y of the panel capacitor Cp. The ground voltage supply control unit 76 controls the supply of the ground voltage level GND to the scan electrode Y of the panel capacitor Cp.

The ground voltage supply control unit 76 comprises a third switch SW3 and a fourth switch SW4, which are connected in series between the ground voltage source and the scan electrode Y of the panel capacitor Cp.

The third switch SW3 is connected between the fourth switch SW4 and the scan electrode Y of the panel capacitor Cp. The third switch SW3 controls the supply of the ground voltage level GND supplied to one terminal of the third switch SW3 to the scan electrode Y of the panel capacitor Cp in response to a third switching control signal supplied from the timing controller.

As a result, when the third switch SW3 is turned on, the ground voltage level GND is supplied to the scan electrode Y of the panel capacitor Cp.

The fourth switch SW4 is connected between the third switch SW3 and the ground voltage source. The fourth switch SW4 electrically connects one terminal of the third switch SW3 and one terminal of the fourth capacitor C4 to the ground voltage source in response to a fourth switching control signal supplied from the timing controller.

As a result, the energy discharged from the panel capacitor Cp is stored in the fourth capacitor C4. Further, the panel capacitor Cp discharges the energy stored in the panel capacitor Cp, and maintains the voltage of the panel capacitor Cp at the ground voltage level GND. This will be described in detail below.

The third capacitor C3 is connected between a common terminal of the second diode D2 and the sixth diode D6, and a common terminal of the first energy recovery control unit 82, the second energy recovery control unit 84, the first energy supply control unit 78, the second energy supply control unit 80 and the fourth capacitor C4. The third capacitor C3 and the second capacitor C2 or the third capacitor C3 and the fourth capacitor C4 supply the energy to the scan electrode Y of the panel capacitor Cp, and also recover a reactive energy, which does not participate in the discharge in the panel capacitor Cp. A voltage charge to the third capacitor C3 equals the voltage of Vs/4 being one quarter of the sustain voltage Vs.

The fourth capacitor C4 is connected between a common terminal of a fifth diode D5 and a tenth diode D10, and a common terminal of the first energy recovery control unit 82, the second energy recovery control unit 84, the first energy supply control unit 78, the second energy supply control unit 80 and the third capacitor C3. The fourth capacitor C4 and the third capacitor C3 supply the energy to the scan electrode Y of the panel capacitor Cp, and also recover a reactive energy, which does not participate in a discharge in the panel capacitor Cp. The voltage of Vs/4 is charged to the fourth capacitor C4.

The first energy supply control unit 78 is connected between the second energy recovery control unit 84, the tenth diode D10 and the eleventh diode D11. The first energy supply control unit 78 controls the supply of the energy stored in the fourth capacitor C4 to the scan electrode Y of the panel capacitor Cp. The first energy supply control unit 78 comprises an eighth switch SW8, a ninth diode D9, and a fourth inductor L4.

The eighth switch SW8 is connected between a common terminal of the third capacitor C3, the fourth capacitor C4 and the second energy recovery control unit 84, and the tenth diode D10. The eighth switch SW8 controls the supply of the energy stored in the fourth capacitor C4 to the scan electrode Y of the panel capacitor Cp in response to an eighth switching control signal supplied from the timing controller.

The ninth diode D9 is connected between a common terminal of the second energy recovery control unit 84 and the scan electrode Y of the panel capacitor Cp, and the eleventh diode D11. The ninth diode D9 prevents an inverse current from the scan electrode Y of the panel capacitor Cp, when supplying the energy stored in the fourth capacitor C4 to the scan electrode Y of the panel capacitor Cp.

The fourth inductor L4 is connected between a common terminal of the eighth switch SW8 and the tenth diode D10, and a common terminal of the ninth diode D9 and the eleventh diode D11. The fourth inductor L4 and the panel capacitor Cp form a serial resonance loop, when the fourth switch SW4 the eighth switch SW8 are turned on.

More specifically, when the fourth switch SW4 the eighth switch SW8 are turned on, the energy stored in the fourth capacitor C4 is supplied to the scan electrode Y of the panel capacitor Cp through the serial resonance loop of the fourth inductor L4 and the panel capacitor Cp.

The second energy supply control unit 80 is connected between the first energy recovery control unit 82, the first diode D1 and the second diode D2. The second energy supply control unit 80 controls the supply of the energy stored in the second and third capacitors C2 and C3 to the scan electrode Y of the panel capacitor Cp. The second energy supply control unit 80 comprises a third diode D3, a fifth switch SW5, and a first inductor L1.

The third diode D3 is connected between a common terminal of the first capacitor C1, the second capacitor C2 and the first energy recovery control unit 82, and a common terminal of the first diode D1 and the first inductor L1. The third diode D3 prevents an inverse current flowing from the scan electrode Y of the panel capacitor Cp to the second capacitor C2, when supplying the energy stored in the second and third capacitors C2 and C3 to the scan electrode Y of the panel capacitor Cp.

The fifth switch SW5 is connected between a common terminal of the third capacitor C3, the fourth capacitor C4 and the first energy recovery control unit 82, and the second diode D2. The fifth switch SW5 controls the supply of the energy stored in the second and third capacitors C2 and C3 to the scan electrode Y of the panel capacitor Cp in response to a fifth switching control signal supplied from the timing controller.

The first inductor L1 is connected between a common terminal of the first diode D1 and the third diode D3, and a common terminal of the fifth switch SW5 and the second diode D2. The first inductor L1 and the panel capacitor Cp form a serial resonance loop, when the second switch SW2 the fifth switch SW5 are turned on. More specifically, when the second switch SW2 the fifth switch SW5 are turned on, the energy stored in the second and third capacitors C2 and C3 is supplied to the scan electrode Y of the panel capacitor Cp through the serial resonance loop of the first inductor L1 and the panel capacitor Cp.

The first energy recovery control unit 82 is connected between the second energy supply control unit 80 and the fifth diode D5. The first energy recovery control unit 82 controls the supply of the reactive energy, which does not participate in the discharge in the panel capacitor Cp, to the second and third capacitors C2 and C3. The first energy recovery control unit 82 comprises a sixth switch SW6, a fourth diode D4, and a third inductor L3.

The sixth switch SW6 is connected between a common terminal of the first capacitor C1, the second capacitor C2 and the third diode D3, and the fourth diode D4. The sixth switch SW6 controls the supply of the reactive energy recovered from the panel capacitor Cp to the second and third capacitors C2 and C3 in response to a sixth switching control signal supplied from the timing controller.

The fourth diode D4 is connected between a common terminal of the fifth diode D5 and the third inductor L3, and the sixth switch SW6. The fourth diode D4 prevents an inverse current from the second and third capacitors C2 and C3, when recovering the energy from the panel capacitor Cp and supplying the recovered energy to the second and third capacitors C2 and C3.

The third inductor L3 is connected between a common terminal of the third capacitor C3, the fourth capacitor C4 and the fifth switch SW5, and the fifth diode D5. The third inductor L3 and the panel capacitor Cp form a serial resonance loop, when the second switch SW2 and the sixth switch SW6 are turned on. More specifically, when the second switch SW2 and the sixth switch SW6 are turned on, the energy discharged from the panel capacitor Cp is supplied to the second capacitor C2 by the serial resonance loop of the third inductor L3 and the panel capacitor Cp.

The second energy recovery control unit 84 is connected between the first energy supply control unit 78, the sixth diode D6 and the seventh diode D7. The second energy recovery control unit 84 controls the supply of the reactive energy, which does not participate in the discharge in the panel capacitor Cp, to the fourth capacitor C4. The second energy recovery control unit 84 comprises a seventh switch SW7, an eighth diode D8, and a second inductor L2.

The seventh switch SW7 is connected between a common terminal of the third capacitor C3, the fourth capacitor C4 and the eighth switch SW8, and the sixth diode D6. The seventh switch SW7 controls the supply of the reactive energy recovered from the panel capacitor Cp to the fourth capacitor C4 in response to a seventh switching control signal supplied from the timing controller.

The energy stored in the fourth capacitor C4 is less than the energy stored in the second and third capacitors C2 and C3.

The eighth diode D8 is connected between a common terminal of the second switch SW2, the third switch SW3, the scan electrode Y of the panel capacitor Cp and the ninth diode D9, and the seventh diode D7. The eighth diode D8 prevents an inverse current from the fourth capacitor C4, when recovering the energy from the panel capacitor Cp and storing the recovered energy in the fourth capacitor C4.

The second inductor L2 is connected between a common terminal of the sixth diode D6 and the seventh switch SW7, and a common terminal of the seventh diode D7 and the eighth diode D8. The second inductor L2 and the panel capacitor Cp form a serial resonance loop, when the fourth switch SW4 and the seventh switch SW7 are turned on. More specifically, when the fourth switch SW4 and the seventh switch SW7 are turned on, the energy discharged from the panel capacitor Cp is supplied to the fourth capacitor C4 by the serial resonance loop of the second inductor L2 and the panel capacitor Cp.

The first diode D1 is connected between the first switch SW1 and the third diode D3. The first diode D1 prevents an inverse current flowing from the sustain voltage source and the scan electrode Y of the panel capacitor Cp to the second energy supply control unit 80.

The second diode D2 is connected between the first switch SW1 and the fifth switch SW5. The first diode D1 and the second diode D2 are connected in parallel. The second diode D2 prevents an inverse current flowing from the sustain voltage source and the scan electrode Y of the panel capacitor Cp to the second energy supply control unit 80.

The fifth diode D5 is connected between a common terminal of the third inductor L3 and the fourth diode D4, and a common terminal of the fourth switch SW4 and the fourth capacitor C4. The fifth diode D5 prevents an inverse current flowing from the first energy recovery control unit 82 to the fourth capacitor C4.

The sixth diode D6 is connected between a common terminal of the second switch SW2 and the third capacitor C3, and a common terminal of the second inductor L2 and the seventh switch SW7. The sixth diode D6 prevents an inverse current flowing from the sustain voltage source and the scan electrode Y of the panel capacitor Cp to the second energy recovery control unit 84.

The seventh diode D7 is connected between a common terminal of the second switch SW2 and the third capacitor C3, and a common terminal of the second inductor L2 and the seventh switch SW7. The sixth diode D6 and the seventh diode D7 are connected in parallel. The seventh diode D7 prevents an inverse current flowing from the sustain voltage source and the scan electrode Y of the panel capacitor Cp to the second energy recovery control unit 84.

The tenth diode D10 is connected between a common terminal of the fourth inductor L4 and the eighth switch SW8, and a common terminal of the third switch SW3 and the fourth capacitor C4. The tenth diode D10 prevents an inverse current flowing from the first energy recovery control unit 82 to the fourth capacitor C4.

The ninth diode D11 is connected between a common terminal of the fourth inductor L4 and the ninth diode D9, and a common terminal of the third switch SW3 and the fourth capacitor C4. The ninth diode D11 prevents an inverse current flowing from the first energy recovery control unit 82 to the fourth capacitor C4.

The first diode D1, the second diode D2, the fifth diode D5, the sixth diode D6, the seventh diode D7, the tenth diode D10, and the eleventh diode D11 may be removed.

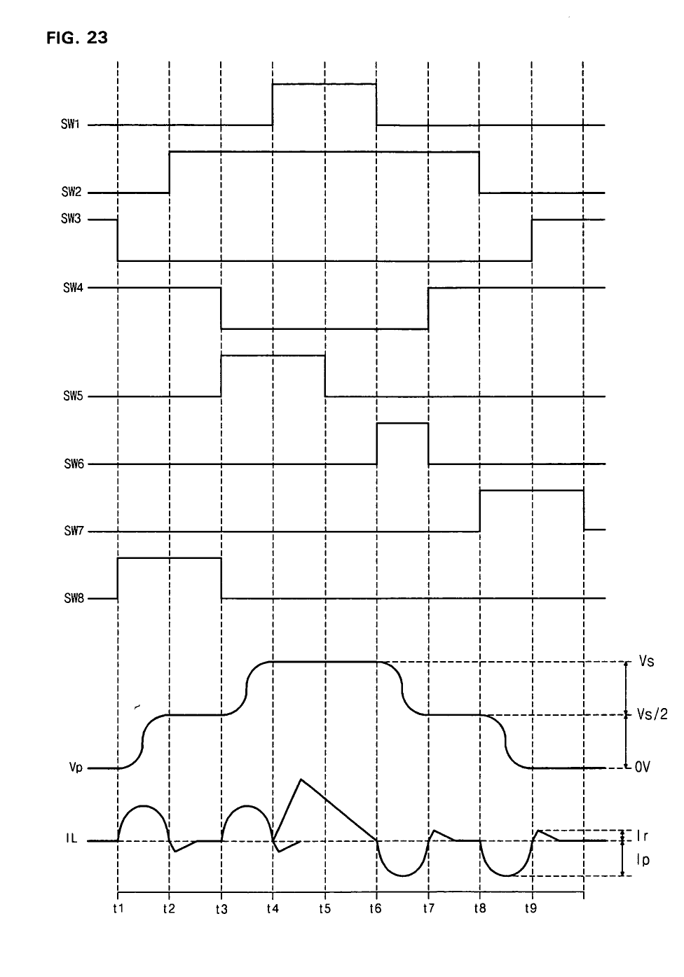

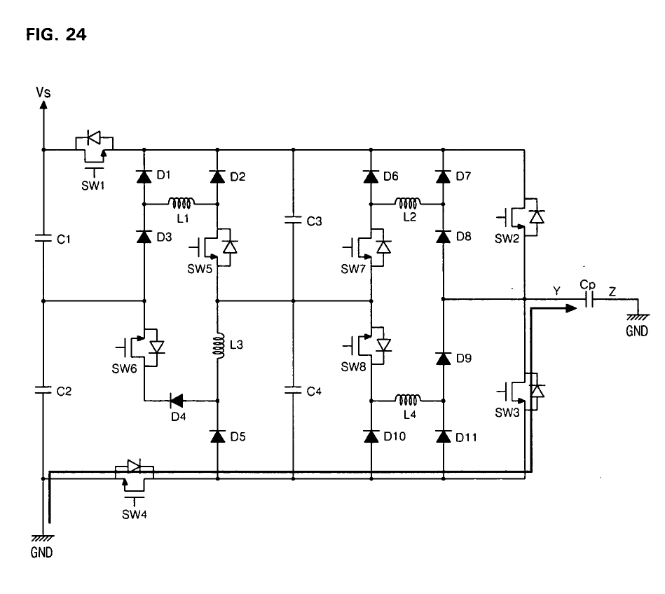

FIG. 23 is a timing chart of switches of the plasma display apparatus according to the third embodiment of the present invention. FIGS. 24 through 32 are circuit diagrams of a current path formed depending on on/off switching operations of the switches of FIG. 23. Suppose that a voltage between both terminals of each of the first and second capacitors C1 and C2 is set to the voltage of Vs/2, and a voltage between both terminals of each of the third and fourth capacitors C3 and C4 is set to the voltage of Vs/4.

Referring to FIGS. 23 through 32, before a time point t1, the third switch SW3 and the fourth switch SW4 are turned on in response to the third switching control signal of a high state and the fourth switching control signal of a high state supplied from the timing controller.

As a result, as illustrated in FIG. 24, a current path passing through the ground voltage source, the fourth switch SW4, the third switch SW3 and the scan electrode Y of the panel capacitor Cp is formed. Accordingly, the voltage of the panel capacitor Cp is maintained at the ground voltage level GND.

At the time point t1, the third switch SW3 is turned off, the fourth switch SW4 remains in a turn-on state before the time point t1, the eighth switch SW8 is turned on in response to the third switching control signal of a low state, the fourth switching control signal of the high state, and the eighth switching control signal of a high state supplied from the timing controller.

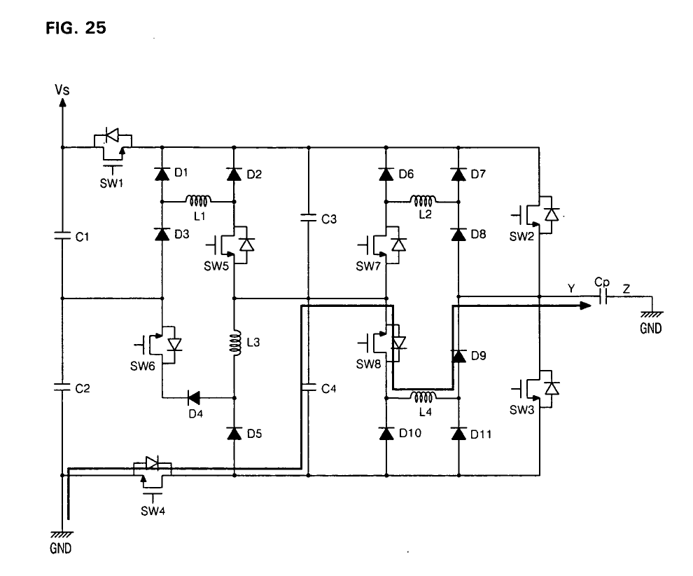

As a result, as illustrated in FIG. 25, a current path passing through the ground voltage source, the fourth switch SW4, the fourth capacitor C4, the eighth switch SW8, the fourth inductor L4, the ninth diode D9 and the scan electrode Y of the panel capacitor Cp is formed, and the fourth inductor L4 and the panel capacitor Cp generate serial resonance. At this time, a voltage Vp and a current ICp of the panel capacitor Cp are expressed by the following equation 13.

$${V}_{p} ( t ) = \frac{Vs}{4} ( 1 - {ⅇ}^{- s {ω}_{n} t} cos {w}_{d} t - \frac{s {ⅇ}^{- s {w}_{n} t}}{\sqrt{1 - {s}^{2}}} sin {w}_{d} t ) \\ {IC}_{p} ( t ) = \frac{{V}_{s} {e}^{{sw}_{n} t}}{4 {Lw}_{d}} sin {w}_{d} t \\ Here , {w}_{n} = \frac{1}{\sqrt{{LC}_{p}}} , s = {R}_{eq} \sqrt{\frac{{C}_{P}}{L}} , {w}_{d} = {w}_{n} \sqrt{1 - {s}^{2}} , {R}_{eq} \qquad [ Equation 13 ]$$

indicates the total of parasitic resistances formed in the current path.

As a result, at the time point t1, the voltage Vp of the panel capacitor Cp rises from the ground voltage level GND (that is, 0V) to the voltage of Vs/2. A current IL flowing in the fourth inductor L4 rises to

$$\frac{{V}_{s}}{2} \sqrt{\frac{{C}_{p}}{L}} ,$$

and then falls to 0.

At a time point t2, the second switch SW2 is turned on and the fourth switch SW4 and the eighth switch SW8 remain in a turn-on state at the time point t1, in response to the second switching control signal of a high state, the fourth switching control signal of the high state and the eighth switching control signal of the high state supplied from the timing controller.

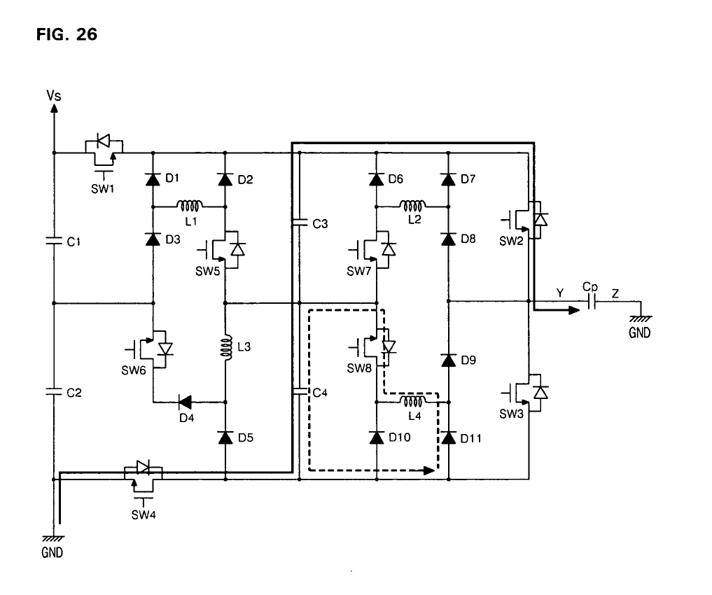

As a result, as illustrated in FIG. 26, a current path passing through the ground voltage source, the fourth switch SW4, the fourth capacitor C4, the third capacitor C3, the second switch SW2 and the scan electrode Y of the panel capacitor Cp is formed.

Accordingly, the voltage of the panel capacitor Cp is maintained at the voltage of Vs/2. An inverse inductor current with a predetermined peak value Ir is generated by a reverse recovery characteristic of the ninth diode D9.

The inverse inductor current flows in the eighth switch SW8, the fourth capacitor C4 and the ninth diode D11. A magnitude of the inverse inductor current is expressed by the following equation 14.

$${I}_{L} ( t ) = - {I}_{r} + \frac{{V}_{s}}{4 L} t \qquad [ Equation 14 ]$$

The inverse inductor current increases in a slope of Vs/4L. The inverse inductor current sharply decreases and a freewheeling current is not generated.

At the time point t3, the second switch SW2 remains in a turn-on state at the time point t2, the fourth switch SW4 and the eighth switch SW8 are turned off, and the fifth switch SW5 is turned on, in response to the fourth switching control signal of a low state, the eighth switching control signal of a low state, the second switching control signal of a high state, and the fifth switching control signal of a high state supplied from the timing controller.

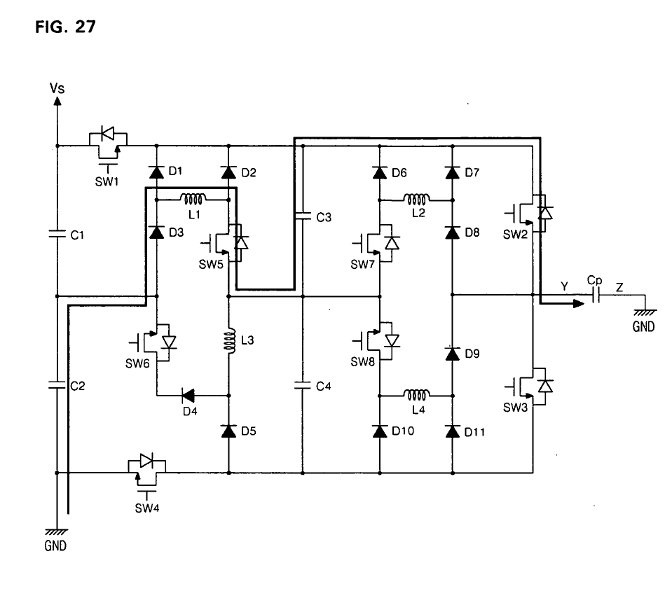

As a result, as illustrated in FIG. 27, a current path passing through the ground voltage source, the second capacitor C2, the third diode D3, the first inductor L1, the fifth switch SW5, the third capacitor C3, the second switch SW2 and the scan electrode Y of the panel capacitor Cp is formed, and the first inductor L1 and the panel capacitor Cp generate serial resonance. At this time, the voltage Vp and the current ICp of the panel capacitor Cp are expressed by the following equation 15.

$${V}_{p} ( t ) = \frac{3 Vs}{4} ( 1 + {ⅇ}^{- s {w}_{n} t} cos {w}_{d} t - \frac{s {ⅇ}^{- s {w}_{n} t}}{\sqrt{1 - {s}^{2}}} sin {w}_{d} t ) \\ {IC}_{p} ( t ) = \frac{{V}_{s} {ⅇ}^{s {w}_{n} t}}{4 L {w}_{d}} sin {w}_{d} t \qquad [ Equation 15 ]$$

As a result, at the time point t3, the voltage Vp of the panel capacitor Cp rises from the voltage of Vs/2 to the sustain voltage Vs. A current IL flowing in the first inductor L1 rises to

$$\frac{{V}_{s}}{4} \sqrt{\frac{{C}_{p}}{L}} ,$$

and then falls to 0.

At the time point t4, the second switch SW2 and the fifth switch SW5 remain in a turn-on state at the time point t3, and the first switch SW1 is turned on, in response to the first switching control signal of a high state, the second switching control signal of the high state and the fifth switching control signal of the high state supplied from the timing controller.

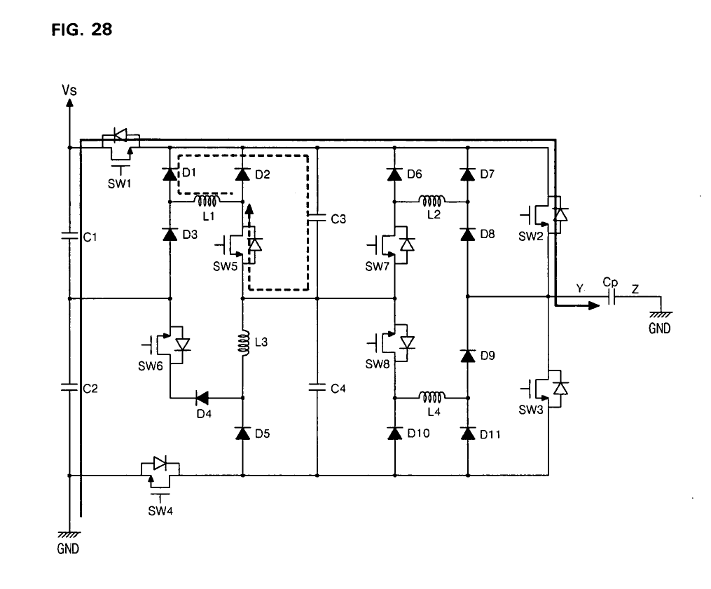

As a result, as illustrated in FIG. 28, a current path passing through the ground voltage source, the second capacitor C2, the first capacitor C1, the first switch SW1, the second switch SW2 and the scan electrode Y of the panel capacitor Cp is formed.

Accordingly, at the time point t4, the voltage of the panel capacitor Cp is maintained at the sustain voltage Vs. An inverse inductor current with a predetermined peak value Ir is generated by a reverse recovery characteristic of the third diode D3.

The inverse inductor current flows in the first diode D1, the third capacitor C3 and the fifth switch SW5. A magnitude of the inverse inductor current is expressed by the above equation 14. The inverse inductor current sharply decreases unlike the energy recovery apparatus of the related art PDP, and a freewheeling current is not generated.

At the time point t5, the first switch SW1 and the second switch SW2 remain in a turn-on state at the time point t4, and the fifth switch SW5 is turned off, in response to the fifth switching control signal of the low state, the first switching control signal of the high state, and the second switching control signal of the high state supplied from the timing controller.

As a result, as illustrated in FIG. 28, a current path passing through the ground voltage source, the second capacitor C2, the first capacitor C1, the first switch SW1, the second switch SW2 and the scan electrode Y of the panel capacitor Cp is formed. Accordingly, the voltage of the panel capacitor Cp is maintained at the sustain voltage Vs.

At the time point t6, the second switch SW2 remains in a turn-on state at the time point t5, the first switch SW1 is turned off, and the sixth switch SW6 is turned on, in response to the first switching control signal of the low state, the second switching control signal of the high state, and the six switching control signal of the high state supplied from the timing controller.

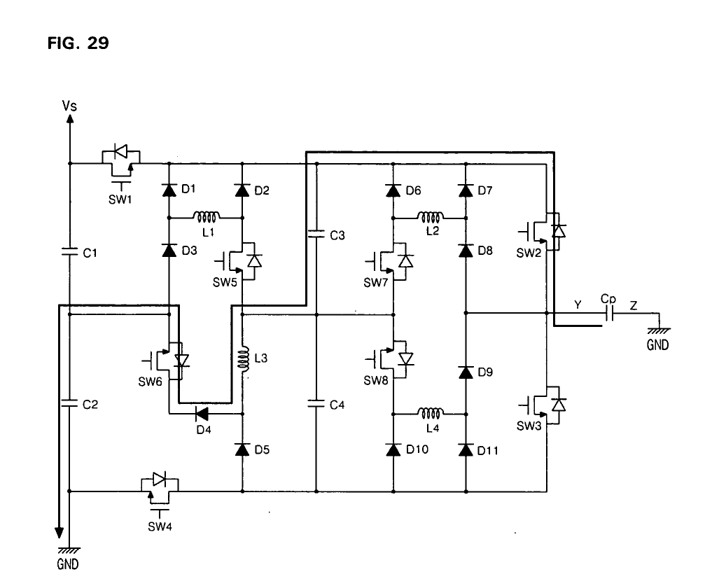

As a result, as illustrated in FIG. 29, a current path passing through the scan electrode Y of the panel capacitor Cp, the second switch SW2, the third capacitor C3, the third inductor L3, the fourth diode D4, the sixth switch SW6 and the second capacitor C2 is formed, and the third inductor L3 and the panel capacitor Cp generate serial resonance. At this time, the voltage Vp and the current ICp of the panel capacitor Cp are expressed by the following equation 16.

$${V}_{p} ( t ) = \frac{3 Vs}{4} ( 1 + {ⅇ}^{- s {w}_{n} t} cos {w}_{d} t - \frac{s {ⅇ}^{- s {w}_{n} t}}{\sqrt{1 - {s}^{2}}} sin {w}_{d} t ) \\ {IC}_{p} ( t ) = - \frac{{V}_{s} {ⅇ}^{s {w}_{n} t}}{4 L {w}_{d}} sin {w}_{d} t \qquad [ Equation 16 ]$$

As a result, at the time point t6, the voltage Vp of the panel capacitor Cp falls from the sustain voltage Vs to the voltage of Vs/2. A current IL flowing in the third inductor L3 falls to

$$- \frac{{V}_{s}}{4} \sqrt{\frac{{C}_{p}}{L}} ,$$

and then rises to 0.

In other words, at the time point t6, the panel capacitor discharges the voltage of Vs/2 in the sustain voltage Vs, which equals to the voltage of the panel capacitor Cp at the time points t4 and t5. The second capacitor C2 recovers the energy discharged from the panel capacitor Cp.

At the time point t7, the second switch SW2 remains in a turn-on state at the time point t6, the six switch SW6 is turned off, and the fourth switch SW4 is turned on, in response to the six switching control signal of the low state, the second switching control signal of the high state, and the fourth switching control signal of the high state supplied from the timing controller.

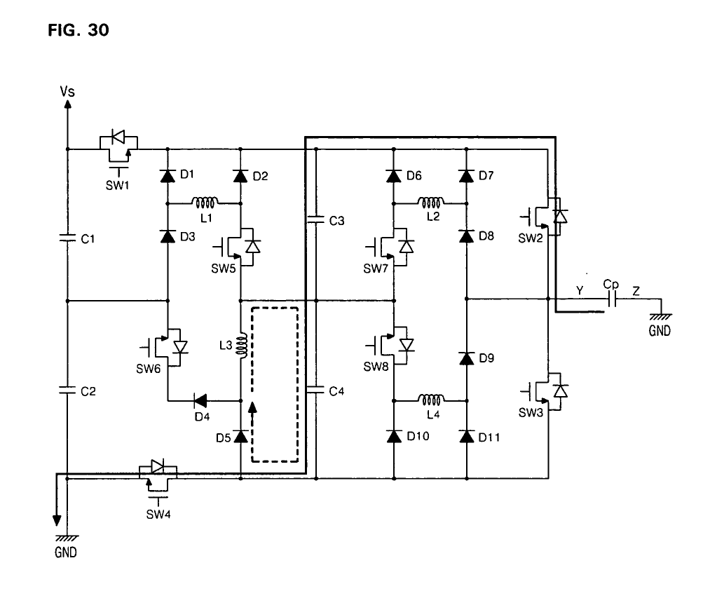

As a result, as illustrated in FIG. 30, a current path passing through the scan electrode Y of the panel capacitor Cp, the second switch SW2, the third capacitor C3, the fourth capacitor C4, the fourth switch SW4 and the ground voltage source is formed.

Accordingly, at the time point t7, the voltage of the panel capacitor Cp is maintained at the voltage of Vs/2. An inverse inductor current with a predetermined peak value Ir is generated by a reverse recovery characteristic of the fourth diode D4.

The inverse inductor current flows in the fourth capacitor C4 and the fifth diode D5. A magnitude of the inverse inductor current is expressed by the above equation 14. The inverse inductor current sharply decreases unlike the energy recovery apparatus of the related art PDP, and a freewheeling current is not generated.

At the time point t8, the fourth switch SW4 remains in a turn-on state at the time point t7, the second switch SW2 is turned off, and the seventh switch SW7 is turned on, in response to the second switching control signal of the low state, the fourth switching control signal of the high state, and the seventh switching control signal of the high state supplied from the timing controller.

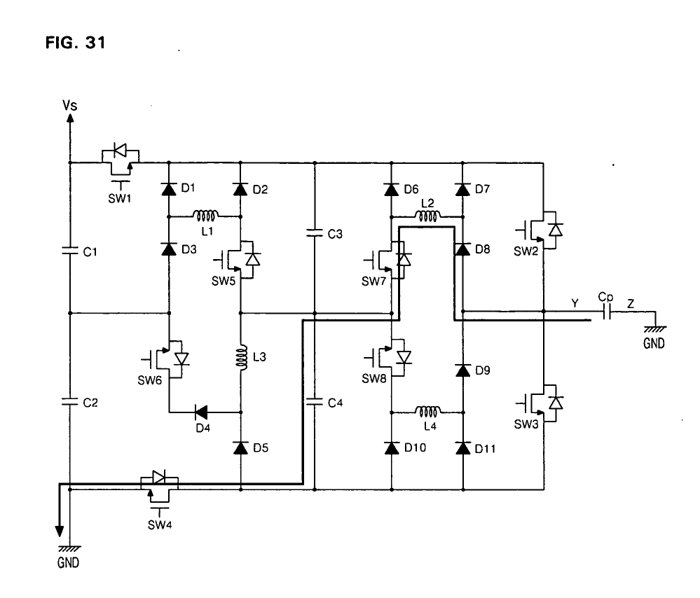

As a result, as illustrated in FIG. 31, a current path passing through the scan electrode Y of the panel capacitor Cp, the eighth diode D8, the second inductor L2, the seventh switch SW7, the fourth capacitor C4, the fourth switch SW4 and the ground voltage source is formed, and the second inductor L2 and the panel capacitor Cp generate serial resonance. At this time, the voltage Vp and the current ICp of the panel capacitor Cp are expressed by the following equation 17.

$${V}_{p} ( t ) = \frac{3 {V}_{s}}{4} ( 1 - {ⅇ}^{- {sw}_{n} t} cos {w}_{d} t - \frac{s {ⅇ}^{- {sw}_{n} t}}{\sqrt{1 - {s}^{2}}} sin {w}_{d} t ) \\ {IC}_{p} ( t ) = - \frac{{V}_{s} {ⅇ}^{{sw}_{n} t}}{4 {Lw}_{d}} sin {w}_{d} t \qquad [ Equation 17 ]$$

As a result, as the time point t8, the voltage Vp of the panel capacitor Cp falls from the voltage of Vs/2 to the ground voltage level GND. A current IL flowing in the second inductor L2 falls to

$$- \frac{{V}_{s}}{4} \sqrt{\frac{{C}_{p}}{L}} ,$$

and then rises to 0.

In other words, at the time point t8, the panel capacitor Cp discharges the voltage of Vs/2, which equals to the voltage of the panel capacitor Cp at the time point t6. The fourth capacitor C4 recovers the energy discharged from the panel capacitor Cp.

At the time point t9, the fourth switch SW4 and the seventh switch SW7 remain in a turn-on state at the time point t8 and the third switch SW3 is turned on, in response to the third switching control signal of the high state, the fourth switching control signal of the high state, and the seventh switching control signal of the high state supplied from the timing controller.

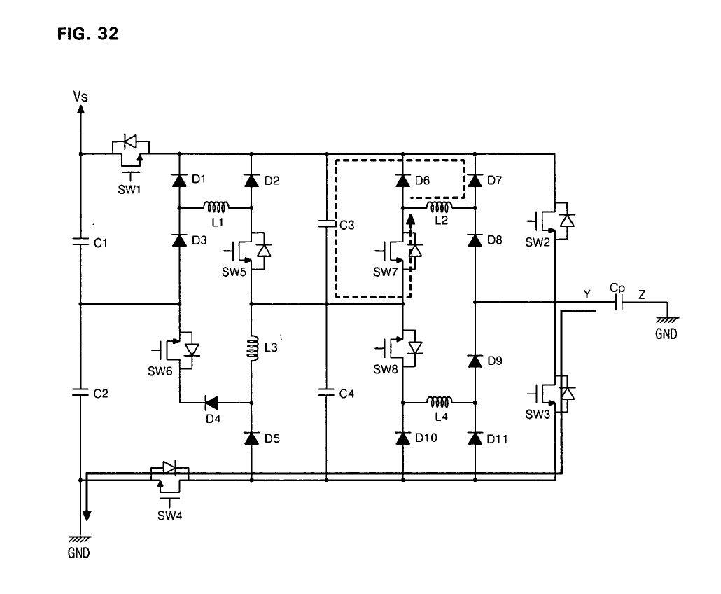

As a result, as illustrated in FIG. 32, a current path passing through the scan electrode Y of the panel capacitor Cp, the third switch SW3, the fourth switch SW4 and the ground voltage source is formed. Accordingly, the voltage of the panel capacitor Cp is maintained at the ground voltage level at the time point t9.

Further, at the time point t9, an inverse inductor current with a predetermined peak value Ir is generated by a reverse recovery characteristic of the eighth diode D8. The inverse inductor current flows in the seventh diode D7, the third capacitor C3 and the seventh switch SW7. A magnitude of the inverse inductor current is expressed by the above equation 14. The inverse inductor current sharply decreases unlike the energy recovery apparatus of the related art PDP, and a freewheeling current is not generated

Subsequently, the switching operations performed at the time points t1 to t9 in the energy recovery apparatus installed in the scan electrode Y of the PDP are repeatedly performed in the energy recovery apparatus installed in the sustain electrode Z of the PDP. Accordingly, a sustain pulse is supplied to the sustain electrode Z of the PDP.

According to the embodiments of the present invention, current stress on the driving elements of the energy recovery apparatus decreases by preventing the generation of the freewheeling current, thereby reducing power consumption.

Further, since the driving elements with the low withstanding conditions and a low parasitic resistance are used, the manufacturing cost of the plasma display apparatus decreases.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode;
a sustain voltage source for supplying a sustain voltage to the plasma display panel;
an inductor for recovering a voltage stored in the plasma display panel by resonance of the inductor and the plasma display panel, and for supplying a recovered voltage to the plasma display panel by resonance of the inductor and the plasma display panel;
an energy supply/recovery capacitor for forming a current path for supplying/recovering a sustain voltage to/from the plasma display panel, and for forming a current path for supplying/recovering one half of the sustain voltage to/from the plasma display panel, the inductor is used to form the current paths; and
a maintenance capacitor, formed between the sustain voltage source and the plasma display panel, for forming a current path for maintaining a voltage of the plasma display panel at one half of the sustain voltage.

2. The plasma display apparatus of claim 1, wherein the energy supply/recovery capacitor comprises a second capacitor and a fourth capacitor,
the second capacitor forms the current path for supplying/recovering the sustain voltage to/from the plasma display panel, and
the fourth capacitor forms the current path for supplying/recovering one half of the sustain voltage to/from the plasma display panel.

3. The plasma display apparatus of claim 1, wherein the energy supply/recovery capacitor comprises a third capacitor, and
the maintenance capacitor for forming the current path for maintaining the voltage of the plasma display panel at one half of the sustain voltage is the third capacitor.

4. The plasma display apparatus of claim 2, wherein the inductor comprises a first inductor and a second inductor,
the first inductor and the second capacitor form the current path for supplying/recovering the sustain voltage to/from the plasma display panel, and
the second inductor and the fourth capacitor form the current path for supplying/recovering one half of the sustain voltage to/from the plasma display panel.

5. The plasma display apparatus of claim 2, wherein the inductor comprises a first inductor, a second inductor, a third inductor and a fourth inductor,
the first inductor and the second capacitor form a current path for supplying the sustain voltage to the plasma display panel,
the second inductor and the fourth capacitor form a current path for recovering one half of the sustain voltage from the plasma display panel,
the third inductor and the second capacitor form a current path for recovering the sustain voltage from the plasma display panel, and
the fourth inductor and the fourth capacitor form a current path for supplying one half of the sustain voltage to the plasma display panel.

6. The plasma display apparatus of claim 1, wherein a current path for supplying the sustain voltage to the plasma display panel is the same as a current path for supplying one half of the sustain voltage to the plasma display panel, and
a current path for recovering the sustain voltage from the plasma display panel is the same as a current path for recovering one half of the sustain voltage from the plasma display panel.

7. The plasma display apparatus of claim 6, wherein the energy supply/recovery capacitor comprises a third capacitor, and
the maintenance capacitor for forming the current path for maintaining the voltage of the plasma display panel at one half of the sustain voltage is the third capacitor.

8. A plasma display apparatus comprising:
a plasma display panel comprising a scan electrode;
a first capacitor and a second capacitor, which are connected between a sustain voltage source and a ground voltage source;
a sustain voltage supply control unit, connected between the sustain voltage source and the scan electrode, for controlling the supply of a sustain voltage to the scan electrode;
a ground voltage supply control unit, connected between the ground voltage source and the scan electrode, for controlling the supply of a ground voltage level to the scan electrode;
a third capacitor connected between the sustain voltage supply control unit and the ground voltage supply control unit;
an energy supply control unit connected between a common terminal of the first capacitor and the second capacitor and the scan electrode, for controlling the supply of energy stored in the second capacitor to the scan electrode;
an energy recovery control unit, connected with the energy supply control unit in parallel between the common terminal of the first capacitor and the second capacitor and the scan electrode, for controlling the supply of energy recovered from the scan electrode of the plasma display panel to the second capacitor; and
a first inductor connected between a common terminal of the energy supply control unit and the energy recovery control unit and the scan electrode.

9. The plasma display apparatus of claim 8, wherein the sustain voltage supply control unit comprises a first switch and a third switch, which are connected in series between the sustain voltage source and the scan electrode, and
the ground voltage supply control unit comprises a second switch and a fourth switch, which are connected in series between the ground voltage source and the scan electrode.

10. The plasma display apparatus of claim 9, wherein the third capacitor is connected between a common terminal of the first switch and the third switch and a common terminal of the second switch and the fourth switch.

11. The plasma display apparatus of claim 8, wherein the energy supply control unit comprises a fifth switch connected between the common terminal of the first capacitor and the second capacitor and the inductor.

12. The plasma display apparatus of claim 8, wherein the energy recovery control unit comprises a sixth switch connected between the common terminal of the first capacitor and the second capacitor and the inductor.

13. A plasma display apparatus comprising:
a plasma display panel comprising a scan electrode;
a first capacitor and a second capacitor, which are connected between a sustain voltage source and a ground voltage source;
a sustain voltage supply control unit, connected between the sustain voltage source and the scan electrode, for controlling the supply of a sustain voltage to the scan electrode;
a ground voltage supply control unit, connected between the ground voltage source and the scan electrode, for controlling the supply of a ground voltage level to the scan electrode;
a third capacitor and a fourth capacitor, which are connected in series between the sustain voltage supply control unit and the ground voltage supply control unit;
a first inductor connected between a common terminal of the first capacitor and the second capacitor and a common terminal of the third capacitor and the fourth capacitor;
a first energy recovery control unit and a second energy supply control unit, which are connected in parallel between the common terminal of the first capacitor and the second capacitor and the first inductor;
a second inductor connected between the common terminal of the third capacitor and the fourth capacitor and the scan electrode; and
a first energy supply control unit and a second energy recovery control unit, which are connected in parallel between the first inductor and the second inductor.

14. The plasma display apparatus of claim 13, wherein the sustain voltage supply control unit comprises a first switch and a second switch, which are connected in series between the sustain voltage source and the scan electrode, and
the ground voltage supply control unit comprises a third switch and a fourth switch, which are connected in series between the ground voltage source and the scan electrode.

15. The plasma display apparatus of claim 13, wherein the first energy supply control unit comprises a fifth switch and a first diode, which are connected between the first inductor and the second inductor.

16. The plasma display apparatus of claim 13, wherein the second energy supply control unit comprises a sixth switch and a second diode, which are connected between the common terminal of the first capacitor and the second capacitor and the first inductor.

17. The plasma display apparatus of claim 13, wherein the first energy recovery control unit comprises a seventh switch and a third diode, which are connected between the common terminal of the first capacitor and the second capacitor and the first inductor.

18. The plasma display apparatus of claim 13, wherein the second energy recovery control unit comprises an eighth switch and a fourth diode, which are connected between the first inductor and the second inductor.

19. The plasma display apparatus of claim 13, wherein the voltage charge to the first capacitor equals 50% of the sustain voltage, and the voltage charge to the second capacitor equals 50% of the sustain voltage, and
the voltage charge to the third capacitor equals 25% of the sustain voltage, and the voltage charge to the fourth capacitor equals 25% of the sustain voltage.

20. A plasma display apparatus comprising:
a plasma display panel comprising a scan electrode;
a first capacitor and a second capacitor, which are connected between a sustain voltage source and a ground voltage source;
a sustain voltage supply control unit, connected between the sustain voltage source and the scan electrode, for controlling the supply of a sustain voltage to the scan electrode;
a ground voltage supply control unit, connected between the ground voltage source and the scan electrode, for controlling the supply of a ground voltage level to the scan electrode;
a third capacitor and a fourth capacitor, which are connected in series between the sustain voltage supply control unit and the ground voltage supply control unit;
a first energy supply control unit and a first energy recovery control unit, which are connected in parallel between a common terminal of the first capacitor and the second capacitor and a common terminal of the third capacitor and the fourth capacitor; and
a second energy supply control unit and a second energy recovery control unit, which are connected in parallel between the common terminal of the third capacitor and the fourth capacitor and the scan electrode.

21. The plasma display apparatus of claim 20, wherein the sustain voltage supply control unit comprises a first switch connected between the sustain voltage source and the third capacitor, and a second switch connected between the third capacitor and the scan electrode, and
the ground voltage supply control unit comprises a third switch connected between the ground voltage source and the fourth capacitor, and a fourth switch connected between the fourth capacitor and the scan electrode.

22. The plasma display apparatus of claim 21, wherein the second energy supply control unit comprises a fifth switch connected between a common terminal of the third capacitor and the fourth capacitor and a common terminal of the first switch and the second switch, and a first inductor connected between the common terminal of the first capacitor and the second capacitor and the fifth switch.

23. The plasma display apparatus of claim 21, wherein the first energy recovery control unit comprises a sixth switch connected between a common terminal of the third switch and the fourth switch and a common terminal of the first capacitor and the second capacitor, and a third inductor connected between a common terminal of the third capacitor and the fourth capacitor and the sixth switch.

24. The plasma display apparatus of claim 21, wherein the second energy recovery control unit comprises a second inductor connected between a common terminal of the first switch and the second switch and a common terminal of the second switch and the scan electrode, and a seventh switch connected between a common terminal of the third capacitor and the fourth capacitor and the second inductor.

25. The plasma display apparatus of claim 21, wherein the first energy supply control unit comprises an eighth switch connected between a common terminal of the third capacitor and the fourth capacitor and a common terminal of the third switch and the fourth switch, and a fourth inductor connected between a common terminal of the third switch and the scan electrode and the eighth switch.

26. The plasma display apparatus of claim 20, wherein the voltage charge to the first capacitor equals 50% of the sustain voltage, and the voltage charge to the second capacitor equals 50% of the sustain voltage, and
the voltage charge to the third capacitor equals 25% of the sustain voltage, and the voltage charge to the fourth capacitor equals 25% of the sustain voltage.

27. A method of driving a plasma display apparatus comprising:
increasing a voltage of a scan electrode of a plasma display panel from a ground voltage level to one half of a sustain voltage;
maintaining the voltage of the scan electrode at one half of the sustain voltage;
increasing the voltage of the scan electrode from one half of the sustain voltage to the sustain voltage;
maintaining the voltage of the scan electrode at the sustain voltage;
decreasing the voltage of the scan electrode from the sustain voltage to one half of the sustain voltage; and
decreasing the voltage of the scan electrode from one half of the sustain voltage to the ground voltage level.
